(19) United States
(12) Patent Application Publication
(10) Pub. No.: US 2026/0272784 A1
(43) Pub. Date: Sep. 17, 2026

(54) MEDICATION SUPPORT SYSTEM

(71) Applicants: Toru OHMINE, Kanagawa (JP); Hirotaka HAYASHI, Aichi (JP); Youhei NIITSUMA, Kanagawa (JP); Yoshihide SUGIYAMA, Gifu (JP); Hiroshi FUJIE, Aichi (JP); Manabu YAMANAKA, Aichi (JP); Takato MOCHIZUKI, Kanagawa (JP); Yu YAMAYA, Gifu (JP); Sachika TASHIRO, Kanagawa (JP); Terumitsu AZUMA, Chiba (JP)

(72) Inventors: Toru OHMINE, Kanagawa (JP); Hirotaka HAYASHI, Aichi (JP); Youhei NIITSUMA, Kanagawa (JP); Yoshihide SUGIYAMA, Gifu (JP); Hiroshi FUJIE, Aichi (JP); Manabu YAMANAKA, Aichi (JP); Takato MOCHIZUKI, Kanagawa (JP); Yu YAMAYA, Gifu (JP); Sachika TASHIRO, Kanagawa (JP); Terumitsu AZUMA, Chiba (JP)

(73) Assignee: ETRIA CO., LTD., Yokohama-shi (JP)

(21) Appl. No.: 19/563,384

(22) Filed: Mar. 11, 2026

(30) Foreign Application Priority Data
Mar. 14, 2025 (JP) 2025-041674

(51) Int. Cl. A61J 7/00; A61J 7/04

(52) U.S. Cl. CPC A61J 7/0084; A61J 7/0069; A61J 7/0454; A61J 7/0463; A61J 2205/10

(57) ABSTRACT

A medication support system includes a medicine dispensing apparatus and an external medicine-dispensing control system. The medicine dispensing apparatus includes a container, a medicine dispensing tray, a conveying device, and a pack data reader. The external medicine-dispensing control system manages the medicine dispensing apparatus, and includes processing circuitry to identify a specific destination of a picked-up one of a plurality of medicine packs in the medicine dispensing tray based on medication-related information of the medicine pack and medicine dispensing data added to the medicine dispensing tray, and change the medicine dispensing data of the specific destination.

### CROSS-REFERENCE TO RELATED APPLICATION

This patent application is based on and claims priority pursuant to 35 U.S.C. § 119 (a) to Japanese Patent Application No. 2025-041674, filed on Mar. 14, 2025, in the Japan Patent Office, the entire disclosure of which is hereby incorporated by reference herein.

### BACKGROUND

### Technical Field

The present disclosure relates to a medication support system.

### Background Art

Medication support systems have been proposed each of which includes a medication support apparatus that performs a medicine dispensing operation where a medicine pack such as a medicine package stored in a container is conveyed and dispensed to a corresponding medicine tray.

These medication support systems perform a medicine dispensing operation where a medicine package is picked up from a container storing medicine packs and is conveyed and dispensed to a specific position of a medicine dispensing tray or a medicine tray. Such a medicine dispensing operation is controlled by a control system provided for a medication support apparatus based on medication-related information such as the name of a patient who takes medicines, the times of medication, and the type or number of medicines.

### SUMMARY

The present disclosure described herein provides a medication support system including a medicine dispensing apparatus and an external medicine-dispensing control system. The medicine dispensing apparatus includes a container to store a plurality of medicine packs to each of which medication-related information including a name of a patient who takes a medicine and a time of medication is added, a medicine dispensing tray to which medicine dispensing data including information about at least one of the plurality of medicine packs to be dispensed is added, a conveying device to pick up one of the plurality of medicine packs from the container and convey the picked-up one of the plurality of medicine packs to a specific destination in the medicine dispensing tray, and a pack data reader to read the medication-related information added to the plurality of medicine packs or the container and the medicine dispensing data added to the medicine dispensing tray and including information about the at least one of the plurality of medicine packs to be dispensed. The external medicine-dispensing control system manages the medicine dispensing apparatus, and includes processing circuitry to identify the specific destination of the picked-up one of the plurality of medicine packs in the medicine dispensing tray based on the medication-related information of the medicine pack and the medicine dispensing data added to the medicine dispensing tray, and change the medicine dispensing data of the specific destination.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A is a schematic front view of a medicine dispensing apparatus that makes up a medication support apparatus.

FIG. 1B is a side view of the medicine dispensing apparatus of FIG. 1A.

FIG. 2A is a plan view of a single medicine package.

FIG. 2B is a side view of the single medicine package of FIG. 2A viewed in a direction indicated by an arrow A.

FIG. 2C is a side view of bound packages.

FIG. 2D is a view of a typical form of continuous packs.

FIG. 3 is an external perspective view of a medicine dispensing tray.

FIG. 4A is a diagram illustrating the attachment of a label with a quick response code to be placed in a subdivision box.

FIG. 4B is a diagram illustrating how a label with a QR CODE is displayed.

FIG. 5A is a vertical sectional view of a cartridge.

FIG. 5B is a bottom view of the cartridge of FIG. 5A.

FIG. 6A is another vertical sectional view of a cartridge different from that of FIG. 5A.

FIG. 6B is a bottom view of the cartridge of FIG. 6A.

FIG. 7 is a schematic plan sectional view of the attaching and detaching mechanisms for the cartridge, which are arranged on a drawer.

FIG. 8 is a schematic plan view of cartridges, illustrating the mechanisms for recognizing each one of the cartridges arranged in a drawer.

FIG. 9A is a front view of a carriage illustrating a schematic configuration or structure of the carriage.

FIG. 9B is a plan view of the carriage of FIG. 9A.

FIG. 10 is a front view of a carriage, illustrating the progression of the operation of the carriage.

FIG. 11A to FIG. 11F are front views of a carriage, illustrating the progression of the operation of the carriage subsequent to the operation illustrated in FIG. 10.

FIG. 12A to FIG. 12C are front views of a carriage, illustrating the progression of the operation of the carriage subsequent to the operation illustrated in FIG. 11A to FIG. 11F.

FIG. 13 is a front view of a carriage, illustrating the operation of scanning the medication-related information displayed on a cartridge.

FIG. 14A is a front view of a conveyor illustrating a schematic configuration of the conveyor.

FIG. 14B is a side view of the conveyor of FIG. 14A.

FIG. 15 is a diagram illustrating the control blocks of a medicine dispensing apparatus.

FIG. 16A and FIG. 16B are schematic diagrams of a cartridge sensor that detects the attachment and detachment (or loading and unloading) of a cartridge.

FIG. 16C is a sectional view of a cartridge tray provided with a cartridge sensor.

FIG. 17A and FIG. 17B are diagrams of a cartridge tray to which a cartridge is not yet attached.

FIG. 17C and FIG. 17D are diagrams illustrating a cartridge tray to which a cartridge is attached.

FIG. 18 is a bottom view of multiple cartridge trays on each of which a cartridge sensor is mounted.

FIG. 19 is a diagram illustrating the control blocks of a medication support system according to the related art.

FIG. 20 is a diagram illustrating the control blocks of a medicine dispensing apparatus according to the related art.

FIG. 21A to FIG. 21C are schematic diagrams illustrating configurations of three kinds of medicine dispensing apparatuses whose medicine dispensing operations are different from each other.

FIG. 22 is a diagram illustrating a case in which a plurality of cartridge trays or medicine dispensing trays of varying configurations or types are placed in a single medicine dispensing apparatus in a mixed manner.

FIG. 23A is a diagram illustrating a QR CODE on a cartridge in the related art.

FIG. 23B is a diagram illustrating a QR CODE on a subdivision box of a medicine dispensing tray in the related art.

FIG. 24 is a diagram illustrating how pack data and medicine dispensing data are stored in the related art.

FIG. 25 is a diagram depicting combinations of medicine dispensing data in a medicine-dispensing data searching system according to the related art.

FIG. 26 is a schematic diagram of an external medicine-dispensing control system and a medicine dispensing apparatus.

FIG. 27 is a schematic diagram of a patient and medicine-dispensing pattern identification controller.

FIG. 28A, FIG. 28B, and FIG. 28C are diagrams illustrating medicine dispensing data when patients who take medicines are identified.

FIG. 29 is a diagram illustrating combinations of medicine-dispensing patterns when medicine dispensing data are matched.

FIG. 30A and FIG. 30B are tables indicating how medicine dispensing data is updated when the information about patients who take medicines is changed.

FIG. 31 is a set of tables indicating combinations of medicine-dispensing patterns handled by a medicine-dispensing pattern identification functional unit when the data of patients who take medicines is changed.

FIG. 32A is a diagram illustrating a QR CODE on a cartridge.

FIG. 32B is a diagram illustrating a QR CODE on a subdivision box of a medicine dispensing tray.

FIG. 33A and FIG. 33B are diagrams illustrating combinations of medicine-dispensing patterns when medicine dispensing data are matched.

FIG. 34A and FIG. 34B are another set of diagrams illustrating combinations of medicine-dispensing patterns when medicine dispensing data are matched.

FIG. 35A and FIG. 35B are still another set of diagrams illustrating combinations of medicine-dispensing patterns when medicine dispensing data are matched.

FIG. 36 is a flowchart of a medicine dispensing operation.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings. First, a medicine dispensing apparatus that makes up a medication support system and is an example of a medication support apparatus is described.

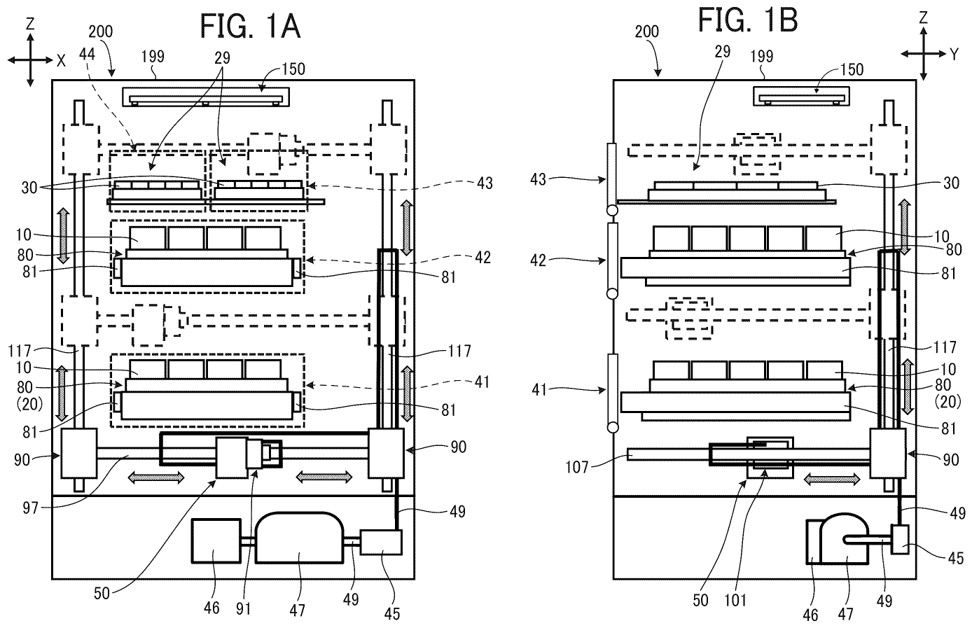

FIG. 1A is a schematic front view of a medicine dispensing apparatus 200.

FIG. 1B is a schematic side view of the medicine dispensing apparatus 200 of FIG. 1A, illustrating its configuration or structure.

As illustrated in FIG. 1A and FIG. 1B, the medicine dispensing apparatus 200 is provided with a cartridge 10 that is also referred to as a first holder, a cartridge tray 20 that is also referred to as a second holder, a drawer 80, medicine dispensing trays 30, a carriage 50 that is an example of a pickup device, a conveyor 90, and a first gate 41 to a fourth gate 44. The right or left direction or the horizontal direction of the medicine dispensing apparatus 200 of FIG. 1A is defined as an X-axis direction, where the right and left directions or the horizontal direction of the medicine dispensing apparatus 200 is also referred to as the width direction. The front-rear direction or depth direction of the medicine dispensing apparatus 200 of FIG. 1B is defined as a Y-axis direction. In FIG. 1A and FIG. 1B, the vertical or orthogonal direction of the medicine dispensing apparatus 200 is referred to as a Z-axis direction. The same applies to the other drawings given below.

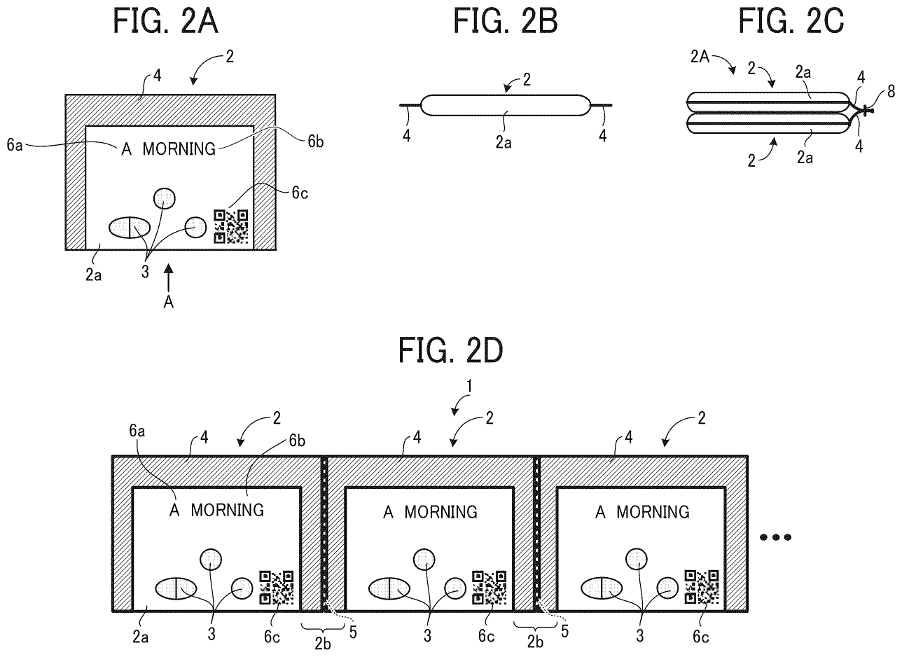

Each one of the multiple cartridges 10 serves as a first holder in which, for example, a plurality of medicine packages packing several kinds of medicines or bound packages (see FIG. 2C) are stored upon being stacked on top of each other in layers. The medicine package according to the present embodiment may be referred to simply as a pack or a medicine pack in the following description. The multiple cartridges 10 are arranged at a middle portion and a lower portion of the housing 199 of the medicine dispensing apparatus 200 through the cartridge tray 20.

The multiple cartridges 10 are attachable to and detachable from the cartridge tray 20 that serves as a second container. The expression “stored upon being stacked on top of each other in layers” in the present disclosure indicates keeping the packs horizontally in such a manner that the front face is viewable.

As will be described later in detail, the cartridge tray 20 can store multiple cartridges 10 upon positioning those cartridges as desired. The cartridge tray 20 serves as a second container in which at least one of the multiple cartridges 10 is placed and held.

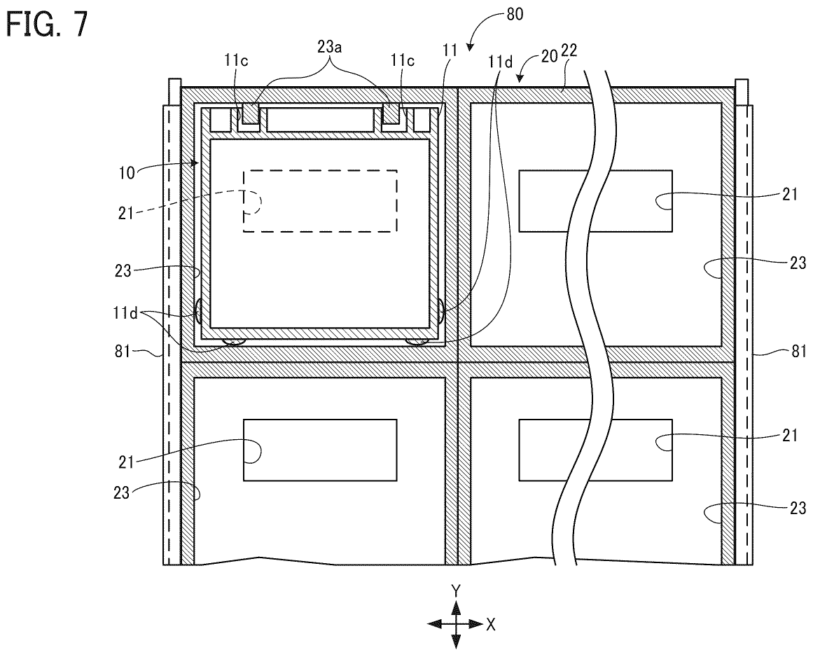

The cartridges 10 are placed in the pair of drawers 80 through the cartridge tray 20. One of the pair of drawers 80 is arranged at a lower area of the housing 199 of the medicine dispensing apparatus 200, and the other one of the pair of drawers 80 is arranged at a middle area of the housing 199 of the medicine dispensing apparatus 200. In the case of the medicine dispensing apparatus 200 as illustrated in FIG. 1A and FIG. 1B, twenty cartridges 10 (4×5=20) are placed and held in the cartridge trays 20 of a single drawer 80, as will be described later in detail with reference to FIG. 7. For the sake of explanatory convenience, each one of the multiple drawers 80 may be referred to as the cartridge tray 20 in the following description.

Each of the multiple cartridges 10 is placed and stored in a partitioned lattice-like side wall and bottom wall in the cartridge tray 20. On the bottom wall of the cartridge tray 20 corresponding to the cartridges 10, a rectangular through opening 21 through which a pack can be picked up from below one of the multiple cartridges 10, making use of the elasticity or free deformation of the pack as will be described later in detail in relation to the operation, is formed as will be described later in detail with reference to FIG. 7.

The drawer 80 can align and hold the cartridge trays 20. In other words, a pair of slide rails 81 are attached to the outer side wall of the drawer 80, and a rail of the housing 199 is disposed on the housing 199 so as to be fitted to the slide rails 81 of the drawer 80. Due to such an engagement between the rail of the housing 199 and the slide rail 81, the drawer 80 in which one of the multiple cartridge trays 20 is stored and held can be pulled out from the housing 199.

The medicine dispensing tray 30 serves as a medicine tray in which the prescribed packs conveyed by the conveyor 90 are arranged. As illustrated in FIG. 1A and FIG. 1B, a pair of medicine dispensing trays 30 are arranged above the multiple cartridges 10 mounted on the cartridge tray 20 in the uppermost one of the multiple drawers 80.

The number of the medicine dispensing trays 30 is not limited to two, and can be increased to a desired number. An area 29 in which the medicine dispensing trays 30 are arranged is an area where the packs are passed to the medicine dispensing tray 30 for automatic medicine dispensing.

The carriage 50 is an example of a pickup device that picks up a specific pack from a cartridge. The conveyor 90 is an example of a conveyor that conveys the pack picked up from the cartridge 10 by the carriage 50.

The carriage 50 and the conveyor 90 pick up a desired pack from the cartridge 10, and convey the pack to a desired point of the medicine dispensing tray 30. In other words, the carriage 50 and the conveyor 90 make up a conveying device that picks up a medicine pack from a container and conveys the picked-up medicine pack to a specific destination on the medicine dispensing tray 30.

Each one of the first gate 41 and the second gate 42 allows one of the multiple cartridges 10 and the cartridge tray 20 to enter and exit the housing 199 through the drawer 80. The multiple cartridges 10 are inserted and set in the housing 199 through each one of the first gate 41 and the second gate 42. The open and close door of one of the first gate 41 and the second gate 42 are opened, and the drawer 80 in which the multiple cartridge trays 20 are aligned is drawn out to the front side. By so doing, the multiple cartridges 10 or the multiple cartridge trays 20 are inserted or withdrawn.

The third gate 43 and the fourth gate 44 allow the multiple medicine dispensing trays 30 that are arranged in two rows at the uppermost stage of the medicine dispensing apparatus 200 to enter and exit the housing 199. The third gate 43 and the fourth gate 44 are arranged such that the packs can be taken out immediately after the packs are set or inserted into the medicine dispensing tray 30.

In the medicine dispensing apparatus 200, two medicine dispensing trays 30 are arranged as described above, and as will be described later in detail, a plurality of medicine dispensing trays 30 are arranged for each time of medication such as a time in the morning, a time in the daytime, a time in the evening, and a time before going to bed. The third gate 43 and the fourth gate 44 for the medicine dispensing tray 30 are also arranged for each one of the medicine dispensing trays 30. Due to such a configuration, another one of the medicine dispensing trays 30 can be taken out even when the medicine dispensing operation is performed on a particular one of the multiple medicine dispensing trays 30.

The multiple cartridge trays 20 as illustrated in FIG. 1A and FIG. 1B are collectively arranged in upper and lower two stages below the multiple medicine dispensing trays 30 arranged uppermost. However, no limitation is intended thereby, and the multiple cartridge trays 20 as illustrated in FIG. 1A and FIG. 1B may collectively be arranged on an upper side or may collectively be arranged on a lower side. Depending on the number of persons in the day-care center or nursing home, the multiple cartridge trays 20 may be arranged in three stages to achieve similar

### Advantageous Effects

FIG. 2A is a typical plan view of a single medicine package 2.

FIG. 2B is a side view of the single medicine package 2 of FIG. 2A viewed in a direction indicated by an arrow A.

FIG. 2C is a side view of the bound packages 2A in which the medicine packages 2 are stacked on top of each other in layers.

FIG. 2D is a view of a typical form of continuous packs 1.

The medicine pack according to the present embodiment includes, for example, the single medicine package 2 and the continuous packs 2A in which a plurality of medicine packages 2 are stacked on top of each other in layers and bound by, for example, a stapler. In FIG. 2C, two medicine packages 2 are bound as the bound packages 1. In FIG. 2A, FIG. 2B, FIG. 2C, and FIG. 2D, a single medicine package 2 is illustrated. However, as a matter of course, the bound packages 2A is also included even when only a single medicine package 2 is illustrated.

As illustrated in FIG. 2A, one medicine package 2 is formed of, for example, a resin film, and medicines 3 such as capsules or tablets are packed in small quantities. The medicine package 2 includes a bag 2a that covers the medicines 3 and a pressure-bonded portion 4 in which three sides of the bag 2a are pressure-bonded or welded. The pressure-bonded portion 4 is hatched in FIG. 2A and FIG. 2D.

Typically, the side of the medicine package 2 on the bag 2a side is folded into two, and the medicines 3 are packed therebetween. The pressure-bonded portion 4 forms a leakage-preventing portion that prevents the medicines 3 from slipping out from the bag 2a. Typically, the medicines 3 in one medicine package 2 is a one-time dosage for a patient who takes medicines.

The medicine package 2 is dispensed and prepared by a drug-dispensing machine installed in, for example, a pharmacy. The dispensing sheets that serve as packages and are used for dispensing the medicines are rolled long-length sheets, and are perforated between packs. The dispensing sheets are rolled in an overlapping manner, and the medicines 3 to be taken are packed in the space between the sheets.

The medicines 3 for a required number of doses are divided into small quantities and packed into multiple medicine packages 2 that form a continuous sheet. The three sides other than the folded portion of each one of the multiple medicine packages 2 around the medicines 3 for a single dose are sealed in turn by the pressure-bonded portion 4. The multiple medicine packages 2 that form such a continuous sheet may be referred to as continuous packs 1 in the following description.

In the continuous packs 1 described with reference to FIG. 2D, the multiple medicine packages 2 are coupled to each other and laid like a belt. In the present embodiment described with reference to FIG. 2D, the medicines 3 for three doses are illustrated. The continuous packs 1 are typical form of drug or medicine that is given or sold at a pharmacy or the like to, for example, a user such as a person who actually takes the medicine 3 in the medicine package 2 and a personal care attendant or assistant who helps or assists the user to take medication, or a staff or the like including a pharmacist, a nurse practitioner, a care manager, or a medication assistant of, for example, various kinds of day-care center, nursing home, or medical institution.

For the sake of explanatory convenience, each one of the packs is filled with the medicines 3 of the same form in the following description. In FIG. 2D, by way of example, each one of the packs is filled with the same capsule and the same tablets. However, no limitation is indicated thereby. As a matter of course, each one of the packs may be filled with different types of medicines depending on, for example, the usage or purposes of the medication.

In the present embodiment described with reference to FIG. 2A, FIG. 2B, FIG. 2C, and FIG. 2D, the medicine package 2 has a rectangular shape in a plan view, and a packaging method in which three sides are crimped and sealed as in the present embodiment is called three-sided packaging in the related art. Most of the drug-dispensing machines available on the market make packs using the three-sided packaging method.

The pressure-bonded portion 4 has a band-like width of about 10 to 15 millimeters (mm). Due to such a configuration, the pressure-bonded portion 4 has higher rigidity than the portion of the bag 2a that is a transparent or semitransparent film where the medicines 3 can be visually recognized therethrough.

In the generation or dispensing by a drug-dispensing machine, a boundary portion 2b that is implemented by perforation 5 is formed in the center of the pressure-bonded portion 4 between a pair of the multiple medicine packages 2 making up the continuous packs 1. The multiple medicine packages 2 are adjacent to each other in an upstream-to-downstream direction. For example, a user who is not handicapped in the hand can obtain one medicine package 2 by tearing off at the perforation 5 by hand or by cutting near the perforation 5 with scissors or a dedicated cutter.

As illustrated in FIG. 2C, bound packages 2A may be used. The bound packages 2A are formed by fastening multiple medicine packages 2 at the center of the three sides of the pressure-bonded portions 4 by stapling 8 (see FIG. 2C) or the like. In FIG. 2C, two medicine packages 2 are fastened together. For example, the bound packages 2A may be formed by taping a plurality of packs together. Alternatively, the bound packages 2A may be, for example, packs of Chinese herbal medicines or sheets of blister packs that are combined together.

As medication-related information such as the name of a patient who takes medicines and the times of medication, the medication-related information is added to the surface of the bag 2a of the medicine package 2. As the medication-related information, medication-related information 6a in which the name of a patient who takes medicines such as the medicine 3 in the medicine package 2 is expressed in texts, medication-related information 6b in which the times of medication at which the medicine 3 is taken is expressed in texts, and medication-related information 6c in which the name of a patient who takes medicines and the times of medication are expressed by a quick response code (QR CODE) are added to the medicine package 2 as illustrated in FIG. FIG. 2A, FIG. 2B, FIG. 2C, and FIG. 2D.

The medication-related information 6a and 6b, which is textual information, and the medication-related information 6c, which is a quick response code (QR CODE), are added to the medicine package 2 as illustrated in FIG. 2A, FIG. 2B, FIG. 2C, and FIG. 2D. However, no limitation is intended thereby, and for example, a radiofrequency identification (RFID) tag that is used when tag information is read using a bar code or short-range radio may be used. Further, the medication-related information may be, for example, the type of medicine or the shape of the medicine prescribed in a pack, the number of tablets, and the images or texts printed on the medicine itself.

As the medication-related information, only individual information may be acquired and used, or items of information may be acquired and used in combination. For example, if confirmation of the patient who takes medicines is required, the information about the name of the patient who takes medicines is sufficient. If it is desired to prevent forgetting to take an important medicine, the information on the number of tablets of the medicine and the shape of the medicine in the pack is confirmed together with the information on the name of the patient who takes medicines. In other words, the medication-related information includes at least one of the name of a patient who takes medicines, the times of medication at which the medicines in a pack are to be taken, and the number of tablets and types of the medicines prescribed in the pack.

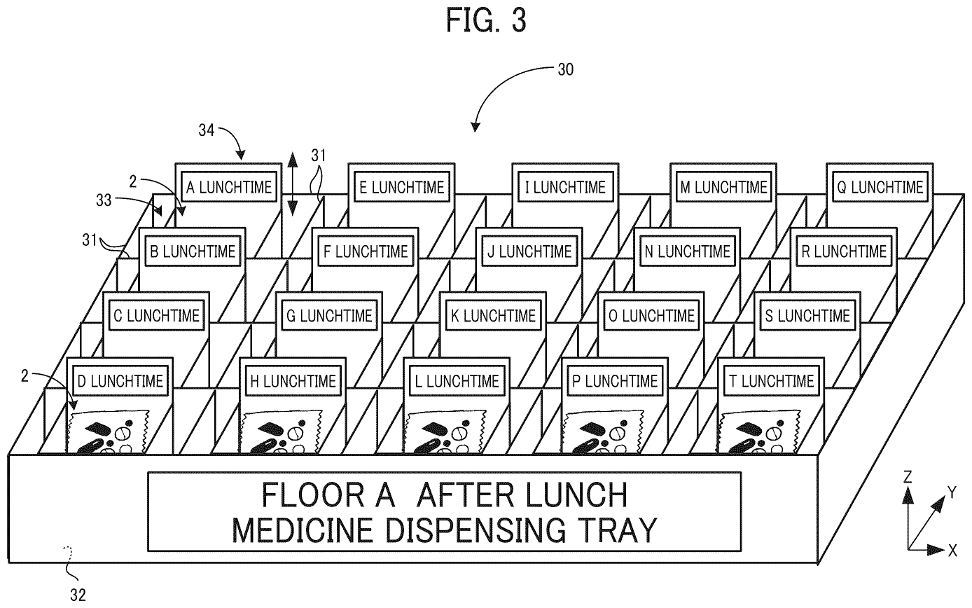

FIG. 3 is an external perspective view of the medicine dispensing tray 30. As illustrated in FIG. 3, each one of the multiple medicine dispensing trays 30 has partition walls 31 that serve as dividers for arranging prescribed packs, and is partitioned by four upright partition walls 31.

The twenty rooms 33 that are formed in each one of the multiple medicine dispensing trays 30 can be expressed as the components of a matrix, including five columns in the X-axis direction or the line feed direction and four rows in the Y-axis direction or the character feed direction. As a result, each one of the twenty rooms 33 of the medicine dispensing trays 30 can be uniquely positioned based on the components and addresses of the matrix of five columns and four rows.

Each one of the multiple medicine dispensing trays 30 has a bottom wall 32 on which the multiple medicine packages 2 are placed. As described above, in the medicine dispensing tray 30, specific one of the multiple packs is placed in specific one of the multiple rooms 33 in a reliable manner by the multiple partition walls 31, which are four partition walls in the present embodiment, and a bottom wall 32 in common, so as not to be mixed up with packs in different one of the multiple rooms 33 or drop off from the bottom wall 32.

In the medicine dispensing tray 30 as illustrated in FIG. 3, “FLOOR A AFTER LUNCH MEDICINE DISPENSING TRAY” displayed on the front outer wall indicates that the tray is the medicine dispensing tray 30 in which the multiple packs to be taken after lunch by a plurality of patients who take medicines and reside in the same floor A of, for example, a day-care center or nursing home are arranged. The same sets of medicines are to be taken after breakfast in the present embodiment, as indicated by the medication-related information 6a and 6b on the medicine package 2, as illustrated in FIG. 2A and FIG. 2D.

FIG. 3 illustrates one of the multiple medicine dispensing trays 30 where a subdivision box 34 attachable to and detachable from each one of the multiple rooms 33 is used. For example, the multiple subdivision boxes 34 hold the multiple medicine packages 2 filled with the medicines 3 to be taken by twenty residents A to T after lunch in a day-care center or nursing home.

In other words, one of the multiple medicine dispensing trays 30 illustrated in FIG. 3 is used to arrange prescribed packs in a predetermined or specific one of the multiple rooms 33 partitioned by a plurality of dividers through the multiple subdivision boxes 34. When the medicine package 2 is placed in the medicine dispensing tray 30, it is not always necessary to use the subdivision boxes 34.

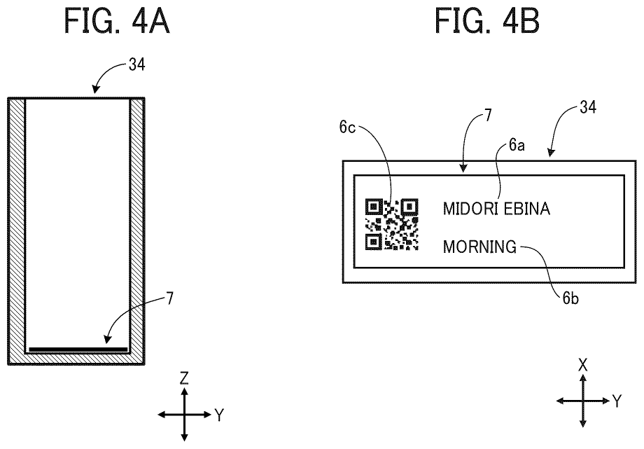

FIG. 4A is a diagram illustrating the attachment of the label 7 with a QR code to be placed in the subdivision box 34 used for the medicine dispensing tray 30.

FIG. 4B is a diagram illustrating how the label 7 with a QR CODE is displayed.

In order to specify the place to which one of the multiple medicine packages 2 picked up from one of the multiple cartridges 10 is to be dispensed, the label 7 with a QR code on which medication-related information 6c indicating the medication-related information 6a and the medication-related information 6b by a QR CODE is printed is pasted on the inner bottom face of one of the multiple subdivision boxes 34 of the medicine dispensing tray 30.

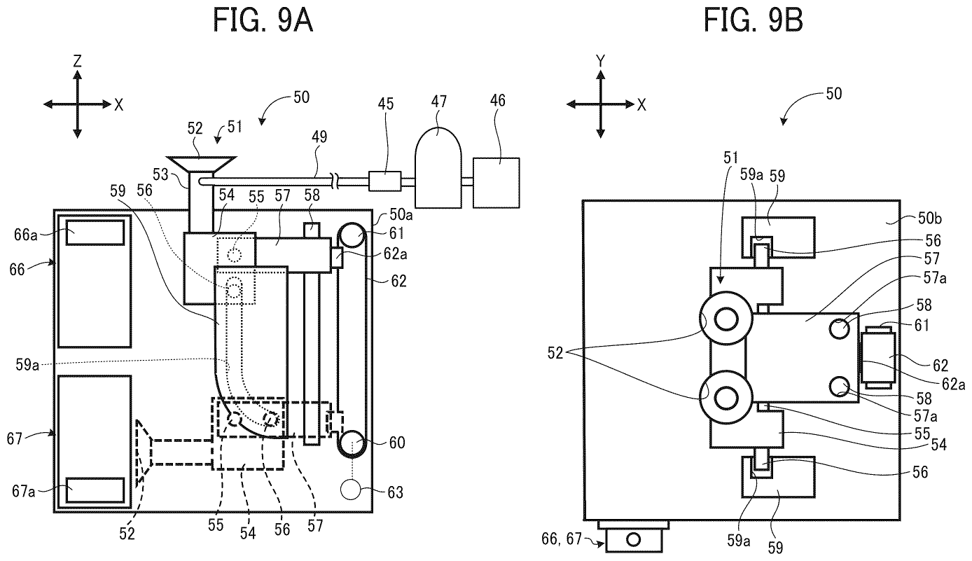

The QR CODE of the label 7 with a QR code is read by the lower QR code reader 67 as will be described later in detail with reference to, for example, FIG. 9A and FIG. 9B, the coordinates of the X position and the Y position, which are the information about the position of the carriage 50, are linked to a quick response code (QR CODE) that indicates the name of a patient who takes medicines and the times of medication. By so doing, the pack that is picked up from one of the multiple cartridges 10 can be dispensed to a desired position. The label 7 with a QR CODE may be directly attached to the subdivision box 34 in the form of a seal, or may be attached to a plate and placed in the subdivision box 34.

The label 7 with a QR code may be pasted to each one of the multiple rooms 33 of one of the multiple medicine dispensing trays 30, or a plate may be arranged when the subdivision box 34 is not to be used. With the use of the multiple subdivision boxes 34, the subdivision box 34 in which the multiple medicine packages 2 are stored can be picked up from the medicine dispensing tray 30, and a proper medicine package 2 can be moved under an occupant or patient who takes medicines. Accordingly, there is no worry about taking a wrong pack or dropping the pack.

In each one of the multiple rooms 33 of the multiple medicine dispensing trays 30, a setting position or insertion position is determined for each patient who takes medicines, depending on the type of medicines in the pack to be taken. In other words, the multiple rooms 33 in one of the multiple medicine dispensing trays 30 may be allocated to patients who take medicines at the same time. In a case where a specific patient who is to take medicines does not take a medicine at a specific time of medication, the arrangement can be made such that a pack is not given to such a specific patient at the specific time of medication.

However, no limitation is intended by the medicine dispensing trays 30 described above. Each one of the multiple rooms 33 of one of the medicine dispensing trays 30 may be allocated for each time of medication of each patient who takes medicines. More specifically, in such an alternative embodiment of the present disclosure, the multiple rooms 33 may be allocated to each of the patients who take medicines in view of the time of medication of each one of the multiple medicine packages 2 to be taken in the morning, in the daytime, in the evening, or before going to bed. The medicine dispensing trays 30 of such cases may be managed on a room-by-room basis or a floor-by-floor basis in day-care centers or nursing homes where patients who take medicines reside, and the multiple medicine packages 2 for that day or a couple of days may be dispersed in advance to the multiple medicine dispensing trays 30.

According to the above alternative embodiment, allocating the rooms 33 based on each time of medication such as a time in the morning, a time in the daytime, a time in the evening, and a time before going to bed can prevent the time of medication from being mistaken by patients who take medicines. The configuration or structure of the multiple medicine dispensing trays 30 is not limited to the embodiments of the present disclosure described above, and various kinds of combinations are theoretically possible between patients who take medicines and the timing at which the medicines are to be taken.

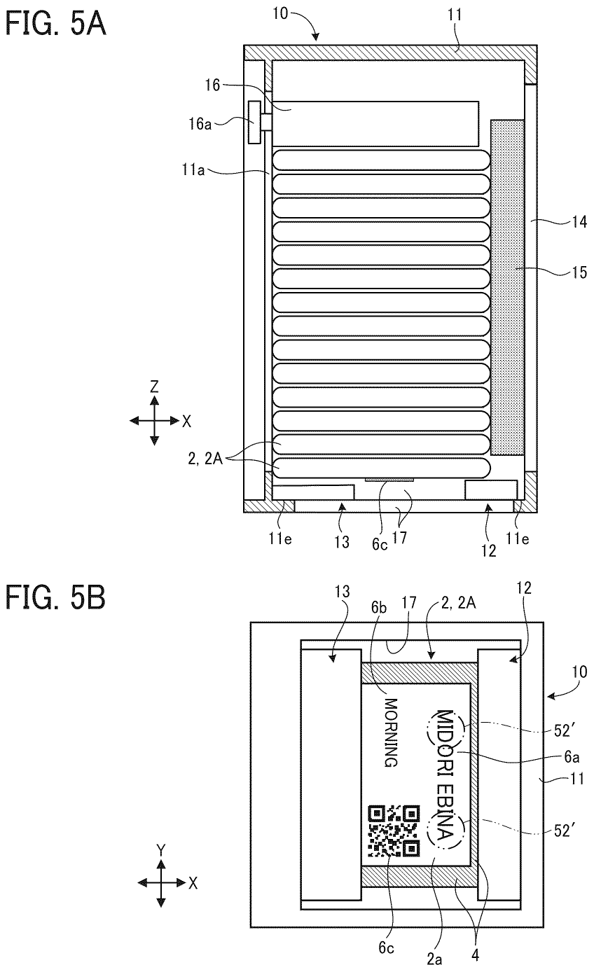

FIG. 5A is a vertical sectional view of the cartridge 10.

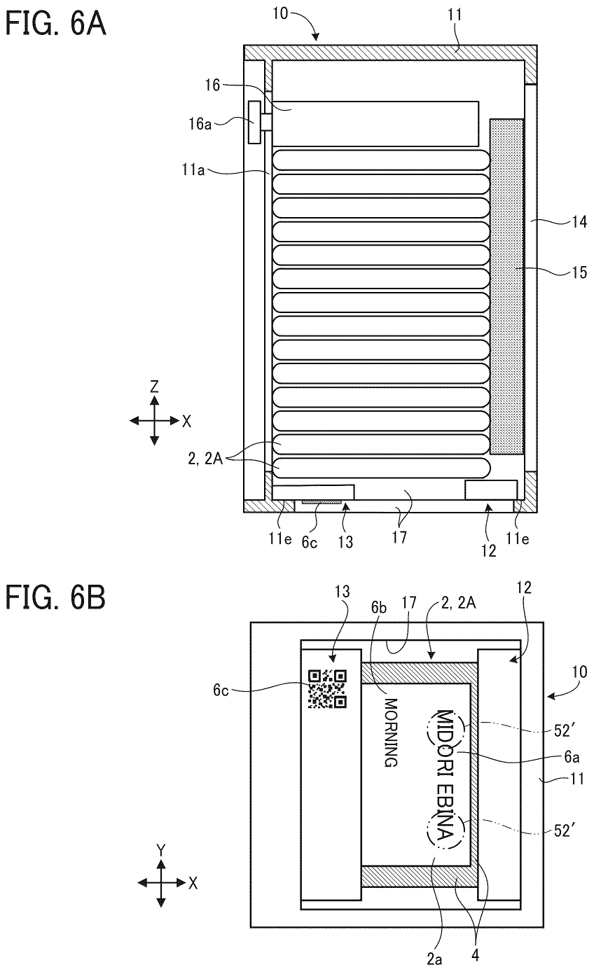

FIG. 6A is another vertical sectional view of one of the multiple cartridges 10 different from that of FIG. 5A.

FIG. 5B is a bottom view of the cartridge 10 of FIG. 5A.

FIG. 6B is a bottom view of the cartridge 10 of FIG. 6A.

In the pair of vertical sections of FIG. 5A and FIG. 6A, the medicine packages 2 are schematically illustrated. In the pair of vertical sections of FIG. 5A and FIG. 6A, support portions such as a right support portion 12 and a left support portion 13 are schematically illustrated.

One of the multiple cartridges 10 as illustrated in FIG. 5A and FIG. 5B is equivalent to one of the multiple cartridges 10 as illustrated in FIG. 6A and FIG. 6B in terms of, for example, the shape. One of the multiple cartridges 10 as illustrated in FIG. 5A and FIG. 5B is different from one of the multiple cartridges 10 as illustrated in FIG. 6A and FIG. 6B in terms of the position at which the QR CODE that indicates the medication-related information 6c is displayed and the member on which the QR CODE that indicates the medication-related information 6c is displayed. The configuration or structure, in terms of, for example, the shape, is described with reference to FIG. 5A and FIG. 5B. Each one of the multiple cartridges 10 includes a casing 11, a lid 14, a pack pickup slot 17, a movable board 16, a pack posture keeper 15, and a right support portion 12 and a left support portion 13, each of which serves as a support portion.

The casing 11 stores, for example, multiple medicine packages 2 or the bound packages 2A. In the following description, a single medicine package 2 will represent such multiple medicine packages 2 or bound packages 2A. For example, the casing 11 is integrally or separately formed using resin.

The lid 14 enables the multiple medicine packages 2 to be loaded or unloaded. The pack pickup slot 17 is formed in a lower portion or a bottom portion of the casing 11, and is used to pick up the medicine package 2 in one of the multiple cartridges 10. Moreover, the pack pickup slot 17 allows the medicine package 2, which is picked up from one of the multiple cartridges 10 by the carriage 50 (see, for example, FIG. 1A, FIG. 1B, FIG. 9A, and FIG. 9B), to pass therethrough.

The movable board 16 prevents the medicine package 2 from falling out, and moves the lowermost one of the medicine packages 2 to a position close to the pack pickup slot 17 after the first one of the maximum number of medicine packages 2 that can be stored in the casing 11 is picked up. The pack posture keeper 15 keeps the posture of the medicine package 2. The right support portion 12 and the left support portion 13 support or hold the medicine packages 2 in the casing 11.

In the present embodiment, the to-be-picked-up portion of one of the multiple medicine packages 2 to be picked up from one of the multiple cartridges 10 by the carriage 50 is at a lower portion or bottom portion of the corresponding one of the multiple cartridges 10. In other words, the to-be-picked-up portion includes the pack pickup slot 17, and the right support portion 12 and the left support portion 13 that serve as a pair of support portions or supporting member and support, at multiple points, one of the multiple medicine packages 2 to be picked up from one of the multiple cartridges 10.

The right support portion 12 and the left support portion 13 are configured to allow one of the multiple medicine packages 2 to pass through when one of the multiple medicine packages 2 is picked up from one of the multiple cartridges 10 by the carriage 50. On the other hand, when any one of the multiple medicine packages 2 is not to be picked up from one of the multiple cartridges 10, the multiple medicine packages 2 are to be stored and held in the casing 11. In order to achieve that, the right support portion 12 and the left support portion 13 are configured to restrict the passage of one of the multiple medicine packages 2.

As described above, the right support portion 12 and the left support portion 13 support or hold the medicine packages 2 in the cartridge 10, and each one of the right support portion 12 and the left support portion 13 is fixed and immovable such that one of the multiple medicine packages 2 can be picked up in a stable manner from one of the multiple cartridges 10 by the carriage 50. The right support portion 12 and the left support portion 13 are a pair of fixation members that are fixed or attached to the pair of bottom-wall inner surfaces 11e of the right bottom-wall edge and left bottom-wall edge of the pack pickup slot 17, respectively.

The pack pickup slot 17 has both a function to allow the suction pad 52 of the carriage 50, as will be described later in detail with reference to, for example, FIG. 9A and FIG. 9B, to pass therethrough in order to pick up one of the multiple medicine packages 2 and a function to allow the picked-up medicine package 2 and the suction pad 52 to pass therethrough. In other words, the pack pickup slot 17 and the above right bottom-wall edge and left bottom-wall edge that are arranged so as to surround the pack pickup slot 17 together serve as a pack passing-through portion according to the present embodiment.

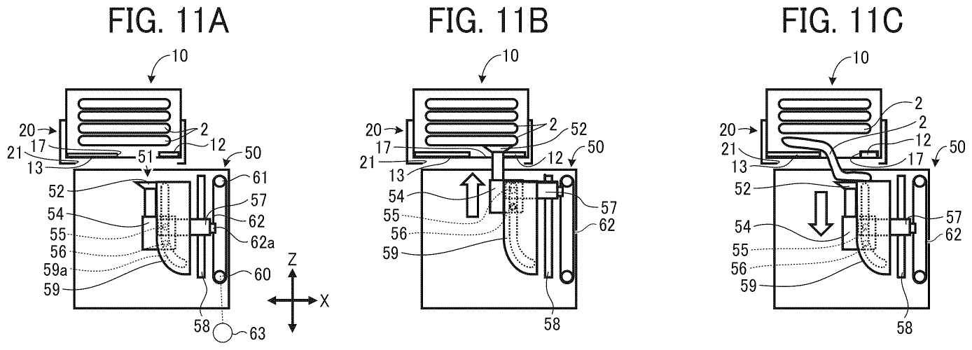

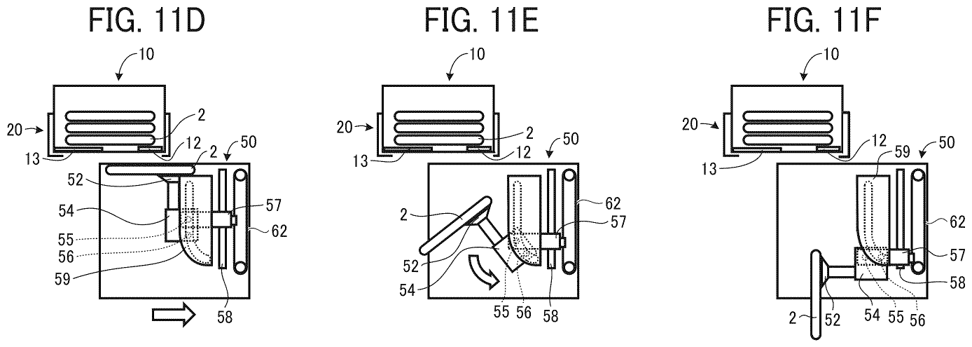

In one of the multiple cartridges 10 illustrated in FIG. 5A and FIG. 5B, a pair of positions 52′ at which the pair of suction pads 52 (as will be described later in detail with reference to FIG. 11C) adsorb or suck up one of the multiple medicine packages 2 stored in one of the multiple cartridges 10 are indicated by a pair of ring-shaped dot-dot-dash lines as illustrated in FIG. 5B. Such a pair of positions may be referred to as a pair of suction pad positions in the following description. The right support portion 12 and the left support portion 13, which are arranged underneath one of the multiple cartridges 10, support the multiple medicine packages 2 in one of the multiple cartridges 10 such that the multiple medicine packages 2 in one of the multiple cartridges 10 do not fall from the pack pickup slot 17.

As will be described later in detail in regard to the operation of the carriage 50, when the medicine package 2 at the bottom of the cartridge 10 is sucked and picked up by the pair of suction pads 52, one of the multiple medicine packages 2 is sucked by the pair of suction pads 52 at a pair of suction-pad positions in the Y-axis direction near both ends of the right support portion 12. When the lowermost one of the multiple medicine packages 2 is picked up from one of the multiple cartridges 10 by the pair of suction pads 52, the pair of suction pads 52 pass near both ends of the right support portion 12 in the Y-axis direction to suck and hold one of the multiple medicine packages 2.

As illustrated in FIG. 5B, two points at which the pair of suction pads 52 contact the medicine package are arranged near both ends of the right support portion 12 in the Y-axis direction. Due to such a configuration, the possibility of an error in which the suction by the pair of suction pads 52 is disabled can be avoided and prevented, and the picking up operation can be done successfully. In other words, as both ends of the multiple medicine packages 2 in the Y-axis direction are sucked by the pair of suction pads 52, the bag 2a of the medicine package 2, which is made of film, is stretched and can withstand the deformation.

Accordingly, both reliable support or holding of the multiple medicine packages 2 in one of the multiple cartridges 10 and smooth removal of one of the multiple medicine packages 2 can be achieved. The pack posture keeper 15 is formed of sponge rubber having appropriate elasticity. The movable board 16 is made of, for example, resin or metal.

The pack posture keeper 15 and the movable board 16 hold the posture of the multiple medicine packages 2 under normal operating conditions in the casing 11. As explicitly illustrated in FIG. 5A, the posture of the multiple medicine packages 2 is held orderly in the Z-axis direction in a substantially horizontal state. In order to achieve the above-described function, the movable board 16 is arranged to move at least one of the multiple medicine packages 2 left in the casing 11 toward the pack pickup slot 17 as moving downward in the casing 11 in the Z-axis direction by its own weight.

As illustrated in FIG. 5A, a long groove 11a that extends in the Z-axis direction with a predetermined width in the X-axis direction is formed in the side wall of the casing 11. A shaft 16a with a flange is arranged at one end of the movable board 16 so as to protrude from the long groove 11a.

As the shaft 16a of the movable board 16 is guided in the Z-axis direction parallel to the long groove 11a, the posture of the multiple medicine packages 2 can be held in the Z-axis direction. In FIG. 5A and FIG. 5B, the multiple medicine packages 2 in the multiple cartridges 10 are stacked on top of each other in layers in a substantially horizontal state. However, in actuality, the left portions of the medicine packages 2 in FIG. 5A and FIG. 5B filled with the medicines 3 are expanding.

The multiple medicine packages 2 are orderly stored in the casing 11 toward the upper side from the pack pickup slot 17 on the right support portion 12 and the left support portion 13. The timing at which the multiple medicine packages 2 are supplied into one of the multiple cartridges 10 may be, for example, the timing at which a patient who takes medicines or occupant is examined in a day-care center or nursing home, which is typically once a two weeks, or the timing at which the multiple medicine packages 2 in one of the multiple cartridges 10 run out.

When some medicine packages 2 are left in one of the multiple cartridges 10 at the time of replenishment, such replenishment is continued from the back of the remaining medicine packages 2. Under normal operating conditions, the above-described setting of the multiple medicine packages 2 into one of the multiple cartridges 10 and the replenishment of the multiple medicine packages 2 are done by staff or the like in a day-care center or nursing home. However, no limitation is indicated thereby. In particular, in configurations where cartridges are used instead of containers and the setting or replenishment of the medicine packages 2 is done automatically, the setting or replenishment of the medicine packages 2 may be done differently.

The lid 14 is opened and closed when the medicine package 2 stored in the cartridge 10 is loaded or unloaded by, for example, a staff in a day-care center or nursing home. As illustrated in FIG. 5A, the lid 14 is formed with a wide length in the Z-axis direction of the casing 11 and has a predetermined opening width.

As illustrated in FIG. 5B, the types of medicine packages 2 in one of the multiple cartridges 10 are sorted or divided based on the timings at which medicines are taken. For example, one cartridge contains medicines to be taken in fourteen days in the morning by, for example, Midori Ebina (Ms. A). In view of the above circumstances, if Ms. Midori Ebina (A) takes the medicines not only in the morning but also in the daytime or in the evening, or before going to bed, four cartridges 10 are required in total.

However, no limitation is intended thereby. For example, the cartridges 10 may be a single cartridge 10 prepared for each patient who takes medicines. A pack to be used in the morning on day one, a pack to be used at lunchtime on day one, a pack to be used in the evening on day one, a pack to be used before going to bed on day one, a pack to be used in the morning on day two, a pack to be used at lunchtime on day two, and a pack to be used in the evening on day two may be stored in the order listed upward from the pack pickup slot 17 parallel to the direction in which packs are taken out from the multiple cartridges 10.

A left flap portion of a lap mechanism provided with a helical torsion coil spring having pressing force within a predetermined range between the rotation axis and the right bottom-wall edge may be used in combination with a right flap portion that is openable and closable and can swing about a rotation axis arranged around the right bottom-wall edge of the pack pickup slot. However, in such a comparative example, the pack tends to be caught and clamped between the left flap portion or the right flap portion and the bottom-wall inner surface of the pack pickup slot when the pack is picked up from one of the cartridge that is an example of a container, and the operation of picking up the medicine package is unstable.

In order to deal with the above technical problems, in some embodiments of the present disclosure, the right support portion 12 and the left support portion 13 are fixed to the bottom-wall inner surface 11e of the pack pickup slot 17 of the casing 11 such that one of the multiple medicine packages 2 can be picked up in a steadily stable manner from one of the multiple cartridges 10 by the carriage 50. In other words, the right support portion 12 and the left support portion 13 are fixed when the right support portion 12 and the left support portion 13 hold both ends of the medicine pack such as the medicine package 2 or the bound packages 2A around the pack pickup slot 17 arranged at the lower portion of one of the multiple cartridges 10.

The medicine package 2 that is stored in the cartridge 10 is supported by a right support portion 12 and a left support portion 13 so as not to drop. The right support portion 12 supports a right end where the medicine package 2 is sucked up, and the left support portion 13 supports a left end on the other side. The right support portion 12 and the left support portion 13 are different in the length of the portion that supports the multiple medicine packages 2, and the length of the portion of the right support portion 12 that supports the multiple medicine packages 2 is shorter than that of the left support portion 13. When the lowermost one of the multiple medicine packages 2 stored in one of the multiple cartridges 10 is adsorbed or sucked by the pair of suction pads 52 and is picked up from the cartridge 10, the medicine pack such as the medicine packages 2 is bent or freely deformed due to its elasticity. Accordingly, the medicine pack can easily be pulled out. Such a configuration and operation are described later in detail with reference to FIG. 11C.

In such a configuration, the pair of support portions including the right support portion 12 and the left support portion 13 are of a fixed type. Accordingly, the front end of the next one of the multiple medicine packages 2 to be taken out can be reliably held and does not jump out or fall off together with one of the multiple medicine packages 2 that is being taken out. As the pair of support portions including the right support portion 12 and the left support portion 13 do not swing or rotate, the medicine package 2 is held with high stability with no deformation or the like due to unintentional nipping or pressing in the returning operation.

As illustrated in FIG. 5A and FIG. 5B, the medication-related information 6a, 6b, and 6c that are displayed on a medicine pack such as the medicine package 2 or the bound packages 2A are exposed through the pack pickup slot 17 of one of the multiple cartridges 10. The medication-related information 6c of the medicine pack can be read by the upper QR code reader 66 mounted on the carriage 50, as will be described later in detail with reference to FIG. 9A and FIG. 9B. For the sake of explanatory convenience, in FIG. 5A and FIG. 5B, the medication-related information 6c is displayed only on, for example, the medicine package 2 or the bound packages 2A that is stored at the bottom of one of the multiple cartridges 10, but the medication-related information 6c is displayed on, for example, all the medicine packages 2 or the bound packages 2A that are stored in one of the multiple cartridges 10.

For example, when a drug-dispensing machine that makes, for example, the medicine package 2 cannot print a QR CODE and the medication-related information 6c such as a QR CODE cannot be applied to a medicine pack such as the medicine package 2 or the bound packages 2A, the QR code may be arranged as illustrated in FIG. 6A and FIG. 6B. In other words, as illustrated in FIG. 6A and FIG. 6B, the label 7 with a QR code (registered trademark) that indicates the medication-related information 6c is pasted to the bottom face of the left support portion 13 close to the pack pickup slot 17.

As a result, the medication-related information 6c of the medicine pack such as the bound packages 2 or the bound medicine packages 2A that is stored in one of the multiple cartridges 10 can be obtained. In order to obtain the medication-related information 6c, the QR CODE may be directly printed on the cartridge 10 instead of pasting a label of the QR CODE.

FIG. 7 is a schematic plan sectional view of the attaching and detaching mechanisms for the cartridge 10, which are arranged on the drawer 80.

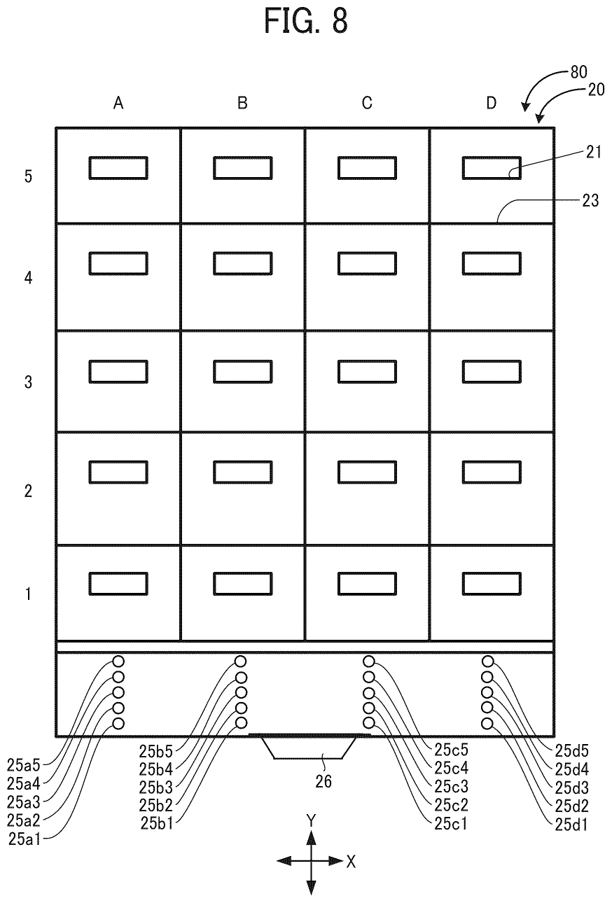

FIG. 8 is a schematic plan view of the cartridges 10, illustrating the mechanisms for recognizing each one of the cartridges, which are arranged in the drawer 80.

As illustrated in FIG. 7, the drawer 80 is configured to allow the multiple cartridges 10 to be attachable and detachable through the cartridge tray 20. In the related art, such a detachable cartridge 10 may be referred to as a container. The drawer 80 is integrally formed with the cartridge tray 20 to hold the cartridge tray 20.

The casing 22 of the cartridge tray 20 in the drawer 80 is provided with a pair of slide rails 81 on the right and left outer side walls, respectively, and each one of the pair of slide rails 81 is slidable with one of the multiple rails provided for the housing 199 (see FIG. 1A and FIG. 1B). Due to such a configuration, the multiple cartridge trays 20 in the drawer 80 can be attached or detached by being pulled out from the housing 199 (see FIG. 1A and FIG. 1B) through the engagement between the slide rail 81 and one of the multiple rails of the housing 199.

As illustrated in FIG. 7, one of the multiple cartridges 10 is attached to and detached from the cartridge tray 20 in the drawer 80 through the engagement and disengagement between a pair of concave portions 11c on the external wall of the casing 11 of the cartridge 10 and a pair of convex portions 23a that are formed on the inner wall of the casing 22 of the drawer 80 and protrude inwardly and the engagement and disengagement between the inner wall of the casing 22 and four hemispherical protrusions 11d on the external wall of the casing 11. With the above-described attaching and detaching mechanism of the drawer 80, the multiple cartridges 10 can be attached or detached easily and with good operability.

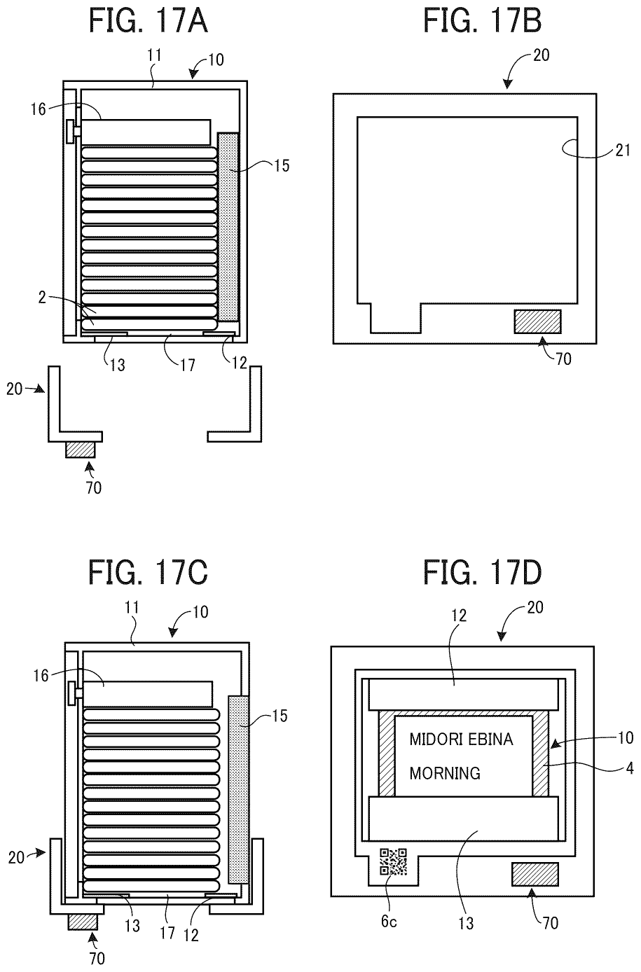

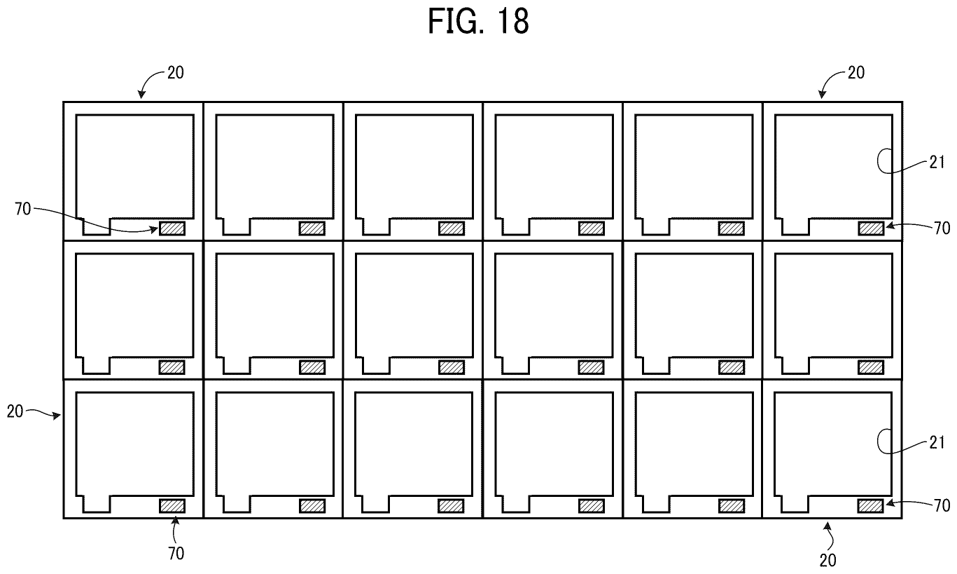

In the above embodiments of the present disclosure, attachment and detachment are enabled by the coupling or engagement of concave and convex portions. However, no limitation is intended thereby, and an elastic member may be arranged in the gap between the inner wall of the casing 22 and the external wall of the casing 11 to enable attachment and detachment. Alternatively, a configuration or structure using magnetic force or a snap-fit assembly method may enable attachment and detachment. As illustrated in FIG. 7 and FIG. 8, a rectangular through opening 21 that communicates with the pack pickup slot 17 of one of the multiple cartridges 10 as illustrated in FIG. 5A, FIG. 5B, FIG. 6A, and FIG. 6B when each one of the multiple cartridges 10 is attached to each container 23 of the cartridge tray 20 is formed on the bottom wall of the cartridge tray 20 of the drawer 80. The rectangular through opening 21 of the cartridge tray 20 is schematically illustrated in a relatively small size in FIG. 7 or FIG. 8, but as will be described later in detail with reference to, for example, FIG. 17A, FIG. 17B, FIG. 17C, FIG. 17D, and FIG. 18, may have a different shape.

As illustrated in FIG. 8, the cartridge tray 20 of the drawer 80 has multiple containers 23 in which twenty cartridges 10 are stored. Each drawer has four columns of A to D in the horizontal direction, and has five rows of 1 to 5 in the vertical direction. The drawer 80 has a grip 26 that is held by hand to insert or withdraw the drawer 80, and information display devices such as light-emitting diodes (LEDs) 25al to 25a5, 25b1 to 25b5, 25cl to 25c5, and 25d1 to 25d5 are arranged near the grip. Due to such a configuration, the arrangement of the multiple cartridges10 can easily be figured out. More specifically, due to such a configuration, at what position one of the multiple cartridges 10 in focus is placed in the cartridge tray 20 of the drawer 80 can easily be figured out at a glance.

In FIG. 8, the light-emitting diode (LED) 25al is used to detect the presence or absence of one of the multiple cartridges 10 attached to or detached from a storage unit A1 of the cartridge tray 20. The storage unit A1 indicates a position or partition that is uniquely determined in the vertical columns and horizontal rows. In a similar manner to the above, the LED 25a2 corresponds to a portion of the storage unit A2 of the cartridge tray 20, and the LED 25a3 corresponds to a portion of the storage unit A3 of the cartridge tray 20. Moreover, the LED 25a4 corresponds to a portion of the storage unit A4 of the cartridge tray 20, and the LED 25a5 corresponds to a portion of the storage unit A5 of the cartridge tray 20. In a similar manner to the above, as illustrated in FIG. 8, each one of three columns of B to D and five rows of 1 to 5 of the containers is provided with an LED that indicates whether one of the multiple cartridges 10, which is attached to and detached from one of the containers, is present.

When multiple information display devices such as the multiple LEDs 25al to 25a5, 25b1 to 25b5, 25c1 to 25c5, and 25d1 to 25d5 are used, for example, a staff who is an operator to attach one of the multiple cartridges 10 to one of the multiple containers 23 may mistake the lighting portion of the LEDs 25al to 25a5, 25b1 to 25b5, 25cl to 25c5, and 25d1 to 25d5. In such cases, the cartridge 10 may erroneously attached to a wrong storage unit other than desired one of the containers 23. In order to handle such a situation, for example, whether the cartridge 10 is present may be electrically or automatically recognized by arranging detection units such as sensors or switches at the containers 23 in place of information display devices such as the multiple LEDs 25al to 25a5, 25b1 to 25b5, 25cl to 25c5, and 25d1 to 25d5.

The container may be provided with, for example, a number, a bar code, a quick response code (QR CODE), or a non-contact integrated circuit (IC) tag such that each one of the containers will be identifiable. It is desired that the system be programmed to remember which container stores whose medicines. Subsequently, the drawer 80 to which the multiple containers are attached is set in the housing 199 of the medicine dispensing apparatus 200, and each one of the multiple containers is identified by the medicine dispensing apparatus 200.

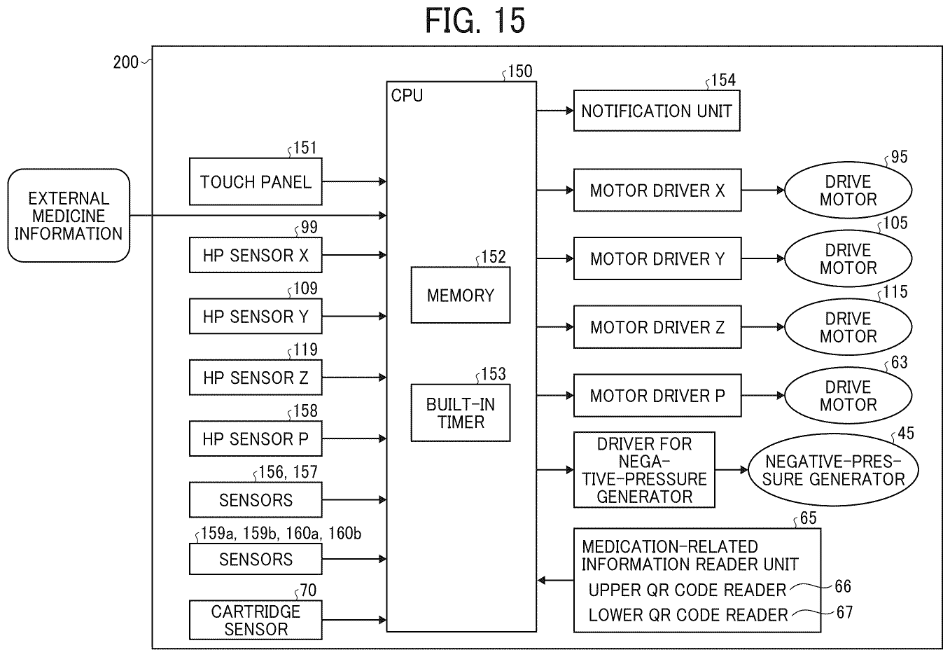

Due to such a configuration, a desired pack can be picked up in the medicine dispensing apparatus 200 without causing any errors. As will be described later in detail, the cartridge tray 20 that is arranged on the drawer 80 as illustrated in FIG. 7 or FIG. 8 may detect the attachment and detachment (or loading and unloading) of the cartridge 10 using a sensor. Such a configuration or structure will be described later in detail with reference to, for example, FIG. 15.

FIG. 9A is a front view of a carriage 50 illustrating a schematic configuration or structure of the carriage 50.

FIG. 9B is a plan view of the carriage 50 of FIG. 9A.

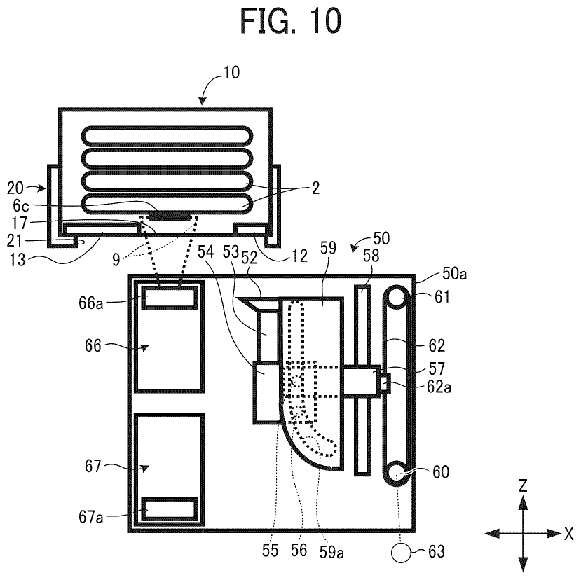

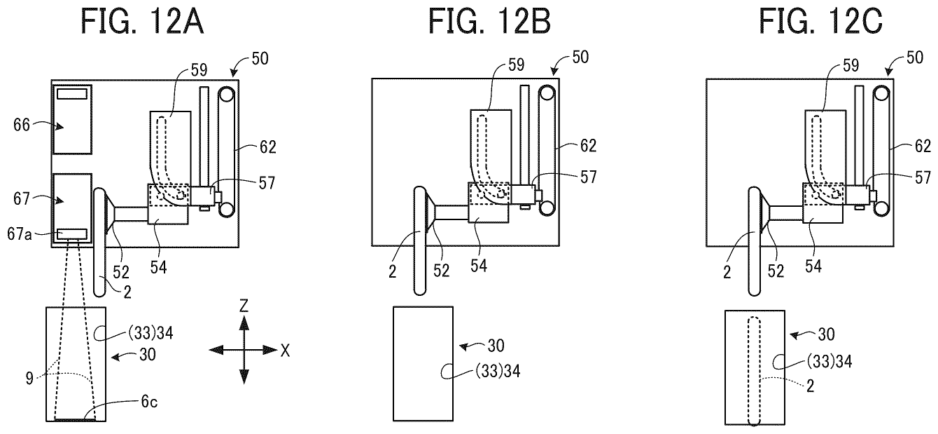

FIG. 10, FIG. 11A to FIG. 11F, and FIG. 12A to FIG. 12C are front views of the carriage 50, illustrating the progression of the operation of the carriage 50.

How elements such as a negative-pressure generator 45 are connected to the carriage 50 is illustrated in FIG. 9A.

As illustrated in FIG. 9A and FIG. 9B, the carriage 50 includes a suction device 51 that picks up and holds one of the multiple medicine packages 2 from one of the multiple cartridges 10. The suction device 51 has a function to such up and separate the medicine package 2.

When the medicine package 2 is to be sucked up, the suction device 51 has a function to suck up the medicine package 2 using the air under negative pressure generated by the negative-pressure generator 45 that serves as a switching unit between positive pressure and negative pressure. The suction device 51 has a function to separate the medicine package 2 using the pressurized air generated by the negative-pressure generator 45 when the medicine package 2 is to be separated.

As illustrated in FIG. 9A, the suction device 51 as described above sucks up one of the multiple medicine packages 2 as the negative-pressure generator 45 transforms the positive pressure generated by an air compressor 46 that serves as an air compressing means into negative pressure through an air tank 47. The air compressor 46 is installed outside the conveyor 90, and is coupled to the suction device 51 through the air tank 47 and the negative-pressure generator 45 by a member for communication such as an air duct 49.

In the air tube 49 between the negative-pressure generator 45 and the suction device 51, a pressure sensor that measures the negative pressure is arranged to determine that the suction device 51 has sucked up one of the multiple medicine packages 2 when the negative pressure measured by a pressure sensor that measures the negative pressure becomes equal to or less than a predetermined value. The air tube 49 is arranged together with, for example, a CABLEVEYOR and a wire harness so as not to be stretched even when the carriage 50 moves inside the medicine dispensing apparatus 200.

In other words, as illustrated in FIG. 1A and FIG. 1B, the air duct 125 has a one-turn path for each one of the X-axis, the Y-axis, and the Z-axis. Firstly, the air duct 49 is extended from the negative-pressure generator 45 in the Z-axis direction, and makes one turn. Secondly, the air duct 49 is extended in the X-axis direction, and makes one turn. Finally, the air duct 49 is extended in the Y-axis direction and makes one turn, and is coupled to the suction device 51.

The suction device 51 includes a pair of suction pads 52 that suck one of the multiple medicine packages 2, and a suction duct 53 coupled to the pair of suction pads 52. The negative-pressure generator 45 is also called a vacuum ejector valve and communicates with the suction duct 53 through the air tube 49.

Each one of the pair of suction pads 52 is an example of an air suction unit or a suction member that sucks up and picks up one of the multiple medicine packages 2 in one of the multiple cartridges 10. As described above, the upper ends of the pair of suction pads 52 as illustrated in FIG. 9A is arranged to absorb one of the multiple medicine packages 2.

The bottom ends of the pair of suction pads 52 as illustrated in FIG. 9A is attached and fixed to the upper end of the suction duct 53 as illustrated in FIG. 9A. The bottom end of the suction duct 53 as illustrated in FIG. 9A is attached and fixed to the suction-pad supporting member 54. A pair of suction pads 52 and suction ducts 53 are arranged in the Y-axis direction.

The carriage 50 is provided with an orientation changing unit used to change the posture of one of the multiple medicine packages 2 picked up from one of the multiple cartridges 10 to a substantially vertical posture. The orientation changing unit in the carriage 50 includes, for example, a suction-pad supporting member 54 coupled to a suction device base 57 through a rotary shaft 55, a guide unit 59 formed with a guide groove 59a having a specific shape, a guide shaft 56 that is consistently fitted into the guide groove 59a of the guide 59 to guide the suction-pad supporting member 54, and a suction-device lifting and lowering unit.

The suction-pad supporting member 54 is coupled to the suction device base 57 through the rotary shaft 55. The suction-pad supporting member 54 may rotatably or pivotably be arranged around the rotary shaft 55 fixed to the suction-pad supporting member 54 within a range of a predetermined angle. Alternatively, the suction-pad supporting member 54 may rotatably or pivotably be arranged around the rotary shaft 55 fixed to the suction device base 57. In other words, in FIG. 9A and FIG. 9B, the distance between the center of the rotary shaft 55 and the center of a guide rod 58 in the X-axis direction, as will be described later in detail, is kept constant when the suction device base 57 moves along the guide rod 58 in up and down directions Z.

The suction-device lifting and lowering unit includes a pair of guide rods 58 that are arranged in the Y-axis direction to guide the suction device base 57 in the Z-axis direction, an endless belt 62 looped around a driving pulley 60 and a driven pulley 61, and a drive motor 63 coupled to a driving pulley 60 through a driving power conveyor such a gear or a belt. The drive motor 63 is an example of a driver circuit or driving source of the suction-device lifting and lowering unit.

The suction device base 57 is coupled and fixed to the endless belt 62 at a belt grip 62a fixed to the right end of the suction device base 57. The pair of guide rods 58 are arranged at two different positions in the Y-axis direction, and extend in the Z-axis direction. The bottom ends of those guide rods 58 are fixed to a base frame 50b of a picking-up frame 50a provided for the carriage 50.

A pair of guiding holes 57a into which the pair of guide rods 58 are inserted are formed around the right end of the suction device base 57. The pulley axis of each one of the driving pulley 60 and the driven pulley 61 is rotatably supported by an immovable member on the picking-up frame 50a. The drive motor 63 is fixed to an immovable member provided for the picking-up frame 50a of the carriage 50.

When the suction device base 57 is lifted or lowered by the operation of the drive motor 63, the suction device base 57 is moved along the pair of guide rods 58 in the Z-axis direction. Accordingly, the posture of the suction device base 57 on the XY plane can be kept constant in a substantially horizontal state. The suction-device lifting and lowering unit is not limited to the above-described up-and-down reciprocating mechanism driven by a belt. Alternatively, for example, the suction-device lifting and lowering unit may have a reciprocating linear motion mechanism using a rack and pinion.

A pair of guide units 59 are arranged on both sides of the suction device 51 in the Y-axis direction across the suction-pad supporting member 54, and the bottom end of the guide unit 59 is fixed to the base frame 50b. The guide shaft 56 is arranged so as to protrude from both ends of the suction-pad supporting member 54 in the Y-axis direction, and is consistently fitted into the guide groove 59a of the guide 59 to guide the suction-pad supporting member 54. As illustrated in FIG. 9A, the guide shaft 56 is located under the rotary shaft 55 of the suction-pad supporting member 54 in the Z-axis direction, at a certain distance from the rotary shaft 55.

When the suction device base 57 is moved in the Z-axis direction by the operation of the drive motor 63, the guide shaft 56 of the suction-pad supporting member 54 is moved in the Z-axis direction parallel to the guide groove 59a having a specific shape while maintaining the posture of the suction device base 57 on the XY plane constant in a substantially horizontal state. Due to such a configuration, the posture of the suction pad 52 can be rotated by approximately 90 degrees. In FIG. 9A, the suction device 51 that is rotated by approximately 90 degrees is indicated by thick broken lines. In the present embodiment, the expression “substantially horizontal state” indicates that the posture of a particular element is within a specific range of tolerance for angle with respect to the horizontal in addition to a state in which the position of a particular element is horizontal.

The guide groove 59a having a specific shape includes the first guide groove that extends in the Z-axis direction with relatively great length so as to hold the posture of the pair of suction pads 52 upward as indicated by solid lines in FIG. 9A through the suction-pad supporting member 54 in a substantially horizontal state as guided by the guide shaft 56. Moreover, the guide groove 59a includes the second guide groove that gently draw an obtuse and shallow arc to the right side as it goes downward to rotate the posture of the suction-pad supporting member 54 and the pair of suction pads 52 by approximately 90 degrees, and the first guide groove and the second guide groove communicate with each other and are coupled to each other.

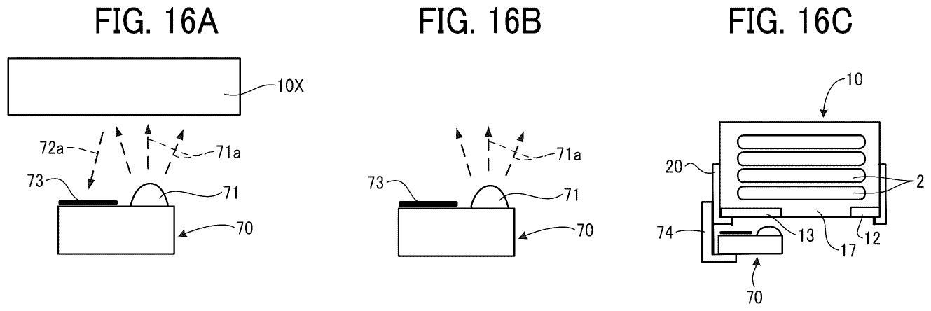

As illustrated in FIG. 9A and FIG. 9B, the carriage 50 is provided with an upper QR code reader 66 that is an example of a data reader that reads the QR CODE that indicates the medication-related information 6c (see FIG. 5A and FIG. 5B) displayed on, for example, the medicine package 2 stored in the cartridge 10. The upper QR code reader 66 has an upper reader unit 66a that reads the medication-related information 6c at an upper portion thereof, and serves as a medication-related information reader unit 65 (which will be described later in detail with reference to, for example, FIG. 15, FIG. 16A, FIG. 16B, and FIG. 16C).

The upper QR code reader 66 is attached to a side of the carriage 50. The upper QR code reader 66 is also used to read the QR CODE that indicates the medication-related information 6c displayed on the label (see FIG. 6A and FIG. 6B) pasted to the left support portion 13 of the pack pickup slot 17 in one of the multiple cartridges 10. Cases are described below in which the QR CODE that indicates the medication-related information 6c is read by the upper reader unit 66a of the upper QR code reader 66 immediately before the medicine package 2 is picked up from one of the multiple cartridges 10 by the carriage 50.

As illustrated in FIG. 9A and FIG. 9B, the carriage 50 is provided with the lower QR code reader 67 that is an example of a data reader or the medication-related information reader unit 65 that reads the QR CODE of the label 7 that is pasted onto the subdivision box 34 as described above with reference to FIG. 4 and indicates the medication-related information 6c. The lower QR code reader 67 has a lower reader unit 67a that also serves as the medication-related information reader unit 65 at a lower portion thereof, and is attached to a side of the carriage 50 under the upper QR code reader 66.

The upper QR code reader 66 and the lower QR code reader 67 make up a pack data reader that reads the medication-related information added to the medicine package or the container and the medicine dispensing data, which is added to the medicine dispensing tray, including the information about the medicine package to be dispensed. Cases are described in which the QR CODE on the subdivision box 34 that indicates the medication-related information 6c is read by the lower reader unit 67a of the lower QR code reader 67 immediately before one of the multiple medicine packages 2 picked up from one of the multiple cartridges 10 is dispensed to one of the multiple subdivision boxes 34 of the medicine dispensing tray 30.

The operation of the carriage 50 will be described below. For the sake of explanatory convenience, it is assumed in the present embodiment that by the operation of the conveyor 90 illustrated in FIG. 1A and FIG. 1B, the carriage 50 is arranged below the cartridge tray 20 held by the upper one of the pair of drawers 80 arranged at an uppermost portion and a lower portion of the housing 199 illustrated in FIG. 1A and FIG. 1B.

In the present embodiment, it is assumed that the cartridges illustrated in FIG. 5A and FIG. 5B and the multiple cartridge trays illustrated in, for example, FIG. 1A and FIG. 1B are used as the multiple cartridges 10 and the multiple cartridge trays 20, respectively.

As illustrated in FIG. 10, the carriage 50 can be moved by the conveyor 90 as illustrated in FIG. 1A and FIG. 1B in the X-axis direction and the Y-axis direction in the lower region of one of the multiple cartridges 10 and the cartridge tray 20. Firstly, as illustrated in FIG. 10, the carriage 50 moves to a position under the cartridge tray 20 that holds the cartridges 10 containing the medicine packages 2 to be picked up.

In other words, the upper reader unit 66a of the upper QR code reader 66 in the carriage 50 is approximately directly below the cartridge tray 20 and one of the multiple cartridges 10, and the QR CODE that indicates the medication-related information 6c on the medicine package 2 stored at the bottom of one of the multiple cartridges 10 can be scanned and read by the upper reader unit 66a of the upper QR code reader 66 through a scanning range 9 within the rectangular through opening 21 of the cartridge tray 20. The carriage 50 reads the QR CODE that indicates the medication-related information 6c displayed on the medicine package 2, through the scanning range 9, using the upper reader unit 66a of the upper QR code reader 66.

Subsequently, the carriage 50 is slightly moved by the conveyor 90 as illustrated in FIG. 1A and FIG. 1B from the position as illustrated in FIG. 10 to the right in the X-axis direction as illustrated in FIG. 11A. As a result, the carriage 50 moves to a position where one of the multiple medicine packages 2 at the bottom can be picked up from the same cartridge 10, and stops moving. At that moment in time, the drive motor 63 of the suction-device lifting and lowering unit is stopped, and the pair of suction pads 52 is at a position under the top face of the pickup device, which indicates the position of the top face of the picking-up frame 50a of the carriage 50.

Subsequently, as illustrated in FIG. 11B, the pair of suction pads 52 are moved upward by the operation of the drive motor 63, and enters from the pack pickup slot 17 between the right support portion 12 and the left support portion 13. Then, as soon as the pair of suction pads 52 contact one of the multiple medicine packages 2 at the bottom of one of the multiple cartridges 10, the pair of suction pads 52 suck that medicine package 2. At that time, the negative-pressure generator 45 has been driven in advance so as to generate a negative pressure, and can suck up the medicine package 2.

Subsequently, as illustrated in FIG. 11C, as the drive motor 63 is reversely operated, the pair of suction pads 52 move downward while sucking one of the multiple medicine packages 2 by the pair of suction pads 52, and the front end of one of the multiple medicine packages 2 is pulled out from one of the multiple cartridges 10. The front end of the medicine package indicates a side of the medicine package to be absorbed or sucked up by the pair of suction pads 52, and the same applies in the following description.

Subsequently, as illustrated in FIG. 11D, by the operation of the conveyor 90, the carriage 50 is moved in the X-axis direction, which is the lateral direction, and the rear end of one of the multiple medicine packages 2 is drawn out or picked up from one of the multiple cartridges 10. Immediately after that, as illustrated in FIG. 11E and FIG. 11F, by the operation of the drive motor 63, one of the multiple medicine packages 2, which is approximately in a horizontal state and is sucked and held by the pair of suction pads 52, is rotated by substantially 90 degrees to change the posture to an approximately vertical or upright posture.

In such a rotational operation, the guide shaft 56 that is arranged on the suction-pad supporting member 54 moves along the guide grooves 59a on the guide unit 59. Accordingly, the posture of one of the multiple medicine packages 2 can be changed from an approximately horizontal posture to an approximately vertical posture. The driving source in the above configuration may be achieved by a series of operations performed by a single drive motor 63.

Then, as illustrated in FIG. 12A, the carriage 50 that includes the pair of suction pads 52 and holds one of the multiple medicine packages 2 in a substantially vertical posture is carried by the conveyor 90 to a predetermined position. When the lower reader unit 67a of the lower QR code reader 67 in the carriage 50 comes to the predetermined position at which the QR CODE that indicates the medication-related information 6c and is displayed at the bottom of predetermined one of the multiple subdivision boxes 34 or rooms 33 of one of the multiple medicine dispensing trays 30 moves to the scanning range 9, the lower reader unit 67a reads the QR CODE that indicates the medication-related information 6c.

Subsequently, the carriage 50 is slightly moved by the conveyor 90 as illustrated in FIG. 1A and FIG. 1B from the position as illustrated in FIG. 12A to the right in the X-axis direction as illustrated in FIG. 12C. As a result, the carriage 50 moves to a position where the picked-up medicine package 2 can be inserted into a predetermined one of the multiple subdivision boxes 34 or rooms 33 of the same medicine dispensing tray 30. Then, the carriage 50 stops moving. Once the carriage 50 is carried to a position substantially directly above a predetermined one of the multiple subdivision boxes 34 or rooms 33 of one of the multiple medicine dispensing trays 30 into which the picked-up medicine package 2 is insertable, the negative-pressure generator 45 is driven only for a short time in order to generate a positive pressure from the negative pressure.

Accordingly, the pressurized air is blown from the pair of suction pads 52 to the medicine package 2. As a result, the suction holding of one of the multiple medicine packages 2 by the pair of suction pads 52 is released, and the medicine package 2 is inserted into a predetermined one of the rooms 33 or the subdivision boxes 34 of one of the multiple medicine dispensing trays 30 (see FIG. 12C). After the above-described operation is performed a plurality of times and desired one of the multiple medicine packages 2 is inserted into one of the multiple rooms 33 that is at a predetermined position of one of the multiple medicine dispensing trays 30, one of the multiple medicine dispensing trays 30 is ejected to the outside of the medicine dispensing apparatus 200 through the third gate 43 (see FIG. 1A and FIG. 1B), and is received by a staff or the like in a day-care center or nursing home or a medication assistant.

Some operations to be performed when the QR CODE that is displayed on one of the multiple cartridges 10 and indicates the medication-related information 6c, as illustrated in FIG. 6A and FIG. 6B, is read by the upper reader unit 66a of the upper QR code reader 66, as illustrated in FIG. 9A and FIG. 9B, are described One of the multiple cartridges 10 as illustrated in FIG. 6A and FIG. 6B is different from one of the multiple cartridges 10 as illustrated in FIG. 5A and FIG. 5B in respect that the position at which the QR CODE that indicates the medication-related information 6c is displayed is changed from the bag 2a of the medicine package 2 to the bottom wall of the left support portion 13 of one of the multiple cartridges 10.

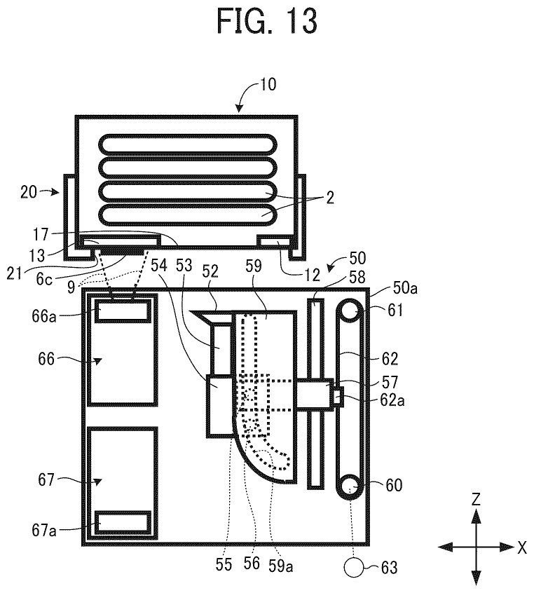

In order to read the QR CODE displayed on the bottom wall of the left support portion 13 of one of the multiple cartridges 10 to indicate the medication-related information 6c, as illustrated in FIG. 13, the carriage 50 is moved to the left in the X-axis direction. More specifically, the carriage 50 is moved to a position within the scanning range 9 in which the QR CODE displayed on the bottom wall of the left support portion 13 of one of the multiple cartridges 10 to indicate the medication-related information 6c can be scanned and read by the upper reader unit 66a of the upper QR code reader 66 in the carriage 50. The carriage 50 reads the QR CODE displayed on the bottom wall of the left support portion 13 in one of the multiple cartridges 10 to indicate the medication-related information 6c, through the scanning range 9, using the upper reader unit 66a of the upper QR code reader 66. The operation of the carriage 50 is equivalent to the operation described above with reference to FIG. 11A to FIG. 11F and FIG. 12A to FIG. 12C, just except the operation described above with reference to FIG. 13.

As described above, in the present embodiment, when desired one of the multiple medicine packages 2 is picked up from one of the multiple cartridges 10, the carriage 50 is positioned or arranged under one of the multiple cartridges 10 and the cartridge tray 20, and such desired one of the multiple medicine packages 2 is taken out in the downward direction of one of the multiple cartridges 10. When one of the multiple medicine packages 2 is taken out from the lower side of one of the multiple cartridges 10 as described above, the next one of the multiple medicine packages 2 automatically moves downward or toward the pack pickup slot 17 due to the self weight of the movable board 16 and the multiple medicine packages 2 left in one of the multiple cartridges 10. Due to such a configuration, the carriage 50 can perform the same operation with a relatively simple configuration regardless of the number of the multiple medicine packages 2 left in one of the multiple cartridges 10.

The configuration and operation of the conveyor 90 will be described below.

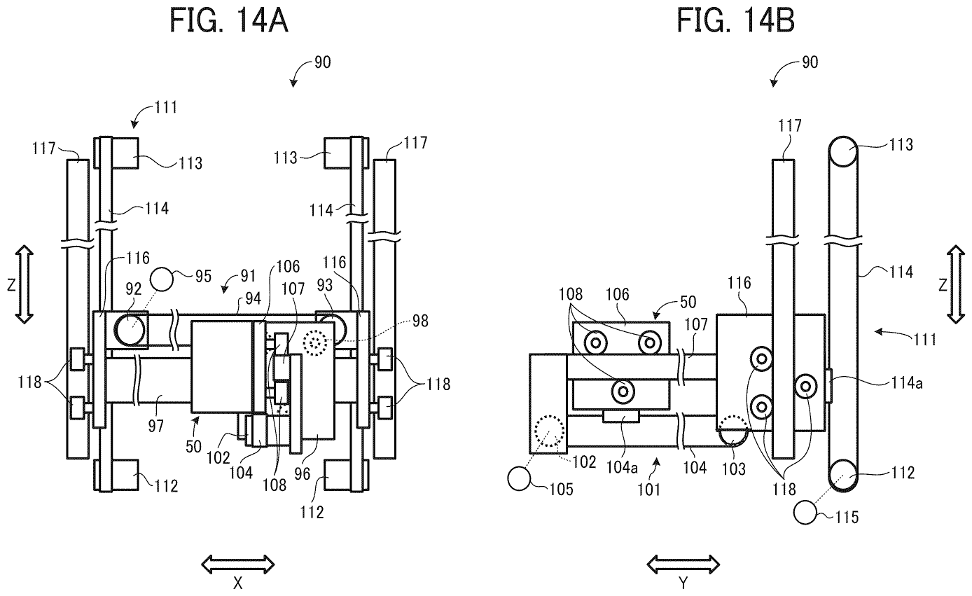

FIG. 14A is a front view of the conveyor 90 illustrating a schematic configuration of the conveyor 90.

FIG. 14B is a side view of the conveyor 90 illustrated in FIG. 14A.

As in the configuration or structure of the medicine dispensing apparatus 200 illustrated in FIG. 1A and FIG. 1B, the multiple cartridges 10 are aligned in a row on a plane under the medicine dispensing tray 30 in the Z-axis direction, and the medicine dispensing tray 30 is located at the uppermost portion of the housing 199 and further above the upper portions of the multiple cartridges 10. In view of these circumstances, the carriage 50 is configured to move in three directions of the X-axis direction, the Y-axis direction, and the Z-axis direction. As described above, the conveyor 90 moves the carriage 50 in the X-axis direction, the Y-axis direction, and the Z-axis direction in order to convey one of the multiple medicine packages 2 picked up from one of the multiple cartridges 10 by the carriage 50 and pass it to one of the multiple medicine dispensing trays 30.

The carriage 50 is moved in the X-axis direction by an X-axis direction conveyance unit 91, and the carriage 50 is moved in the Y-axis direction by a Y-axis direction conveyance unit 101. The carriage 50 is moved in the Z-axis direction by a Z-axis direction conveyance unit 111. These three conveyors have a similar configuration or structure. The X-axis direction conveyance unit 91 includes an X-adaptor 96 attached to the carriage 50, an X-guide unit 97 that guides the carriage 50 in the X-axis direction through the X-adaptor 96, an endless belt 94 looped around a driving pulley 92 and a driven pulley 93, and a drive motor 95 coupled to the driving pulley 92 through a driving force conveyor such as a gear or a belt for the conveyance in the X-axis direction.

As illustrated in FIG. 14A, three rollers 98 are attached to the X-adaptor 96 so as to clamp the X-guide unit 97. Due to such a configuration, the X-adaptor 96 can roll over the X-guide unit 97. Note also that two of the three rollers 98 are hidden by the carriage 50 and invisible in FIG. 14A. The X-adaptor 96 is fixedly coupled to the endless belt 94 through a belt grip. When the drive motor 95 is driven to rotate due to the above configuration or structure of the X-axis direction conveyance unit 91, the driving force is conveyed to the endless belt 94 through the driving force conveyor and the driving pulley 92, and the endless belt 94 runs in rotation. Accordingly, the carriage 50 moves in the X-axis direction along the X-guide unit 97 together with the X-adaptor 96.

The Y-axis direction conveyance unit 101 includes a Y-adaptor 106 attached to the carriage 50, a Y-guide unit 107 that guides the carriage 50 in the Y-axis direction through the Y-adaptor 106, an endless belt 104 looped around a driving pulley 102 and a driven pulley 103, and a drive motor 105 coupled to the driving pulley 102 through a driving force conveyor such as a gear or a belt for the conveyance in the Y-axis direction. Three rollers 108 are attached to the Y-adaptor 106 so as to clamp the Y-guide unit 107. Due to such a configuration, the Y-adaptor 106 can roll over the Y-guide unit 107.

The Y-adaptor 106 is coupled and fixed to the endless belt 104 through a belt grip 104a. When the drive motor 105 is driven to rotate due to the above configuration or structure of the Y-axis direction conveyance unit 101, the driving force is conveyed to the endless belt 104 through the driving force conveyor and the driving pulley 102, and the endless belt 104 runs in rotation. Accordingly, the carriage 50 moves in the Y-axis direction along the Y-guide unit 107 together with the Y-adaptor 106.

The Z-axis direction conveyance unit 111 includes a pair of Z-adaptor 116 attached to both ends of the X-guide unit 97 in the X-axis direction, a pair of Z-guide units 117 that guides the carriage 50 in the Z-axis direction through the X-guide unit 97 and the pair of Z-adaptors 116, an endless belt 114 looped around a driving pulley 112 and a driven pulley 113, and a drive motor 115 coupled to the driving pulley 112 through a driving force conveyor such as a gear or a belt for the conveyance in the Z-axis direction. In the Z-axis direction conveyance unit 111, the driving pulley 112, the driven pulley 113, and the endless belt 114 are arranged on both sides in the X-axis direction. The drive motor 115 is provided for only one of the pair of driving pulleys 112.

Three rollers 118 are attached to each one of the pair of Z-adaptors 116 so as to clamp corresponding one of the pair of Z-guide units 117. Due to such a configuration, the pair of Z-adaptors 116 can roll over the pair of Z-guide units 117, respectively. The pair of Z-adaptors 116 are coupled and fixed to the pair of endless belts 114 through a pair of belt grips 114a, respectively.

With the above-described configuration of the Z-axis direction conveyance unit 111, as the drive motor 115 is driven, the driving force is conveyed to the endless belt 114 through the driving force conveyor and the driving pulley 112. Accordingly, the endless belt 114 rotates, and the carriage 50 moves in the Z-axis direction along the Z-guide unit 117 together with the X-guide unit 97 and the Z-adaptor 116. In FIG. 14, the carriage 50 moves in the triaxial directions including the X-axis direction, the Y-axis direction, and the Z-axis direction. However, no limitation is indicated thereby. For example, when the cartridge 10 is arranged above the carriage 50 and the medicine dispensing tray 30 is arranged below the carriage 50, the carriage 50 only needs to move in the X-axis direction and the Y-axis direction. In such cases, the number of axes of motion can be reduced by one.

In the present embodiment, the QR code reader that is an example of a data reader is divided into two sections including the upper QR code reader 66 provided with the upper reader unit 66a and the lower QR code reader 67 provided with the lower reader unit 67a. However, no limitation is indicated thereby, and one integrated QR code reader may be used. As will be described later in detail, control may be done, and the reading operation of the QR code may automatically start upon detecting that the cartridges 10 or the medicine dispensing tray is properly stored or both the cartridges 10 and the medicine dispensing tray are properly stored.

The reading operation of the QR CODE may start immediately before one medicine pack is picked up from one of the multiple cartridges 10 or immediately before medicines are dispensed to one of the multiple medicine dispensing trays 30. The reading operation of the QR code may start at any time specified by an operation made by a user. No limitation is intended thereby in terms of a method for implementation. In the present embodiment, the QR CODE on the carriage 50 and the QR CODE on each one of the multiple subdivision boxes of the medicine dispensing tray 30 are read, and multiple items of information are stored. Then, such multiple items of information are used to make comparisons when medicines are dispensed, as will be described later in detail with reference to FIG. 16A, FIG. 16B, and FIG. 16C.

FIG. 15 is a diagram illustrating the control blocks of the medicine dispensing apparatus 200.

As illustrated in FIG. 15, the medicine dispensing apparatus 200 includes a central processing unit (CPU) that is an example of a controller 150 that controls the operation of, for example, the components or elements of the medicine dispensing apparatus 200.

For example, the CPU may be provided with a built-in memory 152 or a built-in timer 153. The CPU according to the present embodiment may provide notification to a staff or the like at a timing consistent with the program or may instruct the medicine dispensing apparatus 200 to perform a particular operation, based on various kinds of input such as the inputs from a sensor as will be described later in detail.

The CPU may have, for example, a computing or control function, and a timer or clocking function. The memory 152 of the controller 150 includes a random-access memory (RAM) that is referred to as a main memory, and a read-only memory (ROM).

The ROM stores, for example, a program readable by the above CPU and various kinds of data in advance. Such a program stored in the ROM may be a program used in the flowchart of the controlling processes as will be described later in detail. The above various kinds of data may be, for example, the data about the relation between the multiple medicine packages 2 and the multiple rooms 33 or the multiple subdivision boxes 34 of one of the multiple medicine dispensing trays 30 allocated to each of the patients who take medicines, the data about the relation between the multiple medicine packages 2 and the multiple rooms 33 or the multiple subdivision boxes 34 of one of the multiple medicine dispensing trays 30 assigned to each one of the times of medication, or the data about the relation between the multiple medicine packages 2 and the multiple rooms 33 or the multiple subdivision boxes 34 of one of the multiple medicine dispensing trays 30 sorted according to the order in which medicines are to be taken.

The CPU has an input and output (I/O) port, and a touch panel 151 that serves as a user interface (UI) is electrically connected to that input and output port of the CPU. However, the user interface (UI) is not limited to the touch panel 151, and may be, for example, a combination of an input device and a display interface such as a combination of a keyboard and a light-emitting diode (LED) display. The CPU according to the present embodiment has an input port, and a medicine-dispensing-tray sensor 156 that detects the type of medicine dispensing tray 30 stored in the medicine dispensing apparatus 200 or determines whether or not there is any medicine dispensing tray 30, and a cartridge sensor 157 that determines whether or not there is any one of the multiple cartridges 10 are electrically connected to the input port of the CPU.

As various types of sensors, a pair of drawer gate opening and closing sensors 159a and 159b that detect the opening and closing of the first gate 41 and the second gate 42 and a pair of medicine-dispensing-tray gate opening and closing sensors 160a and 160b that detect the opening and closing of the third gate 43 and the fourth gate 44 are electrically connected to the input port of the CPU. The medicine-dispensing-tray sensor 156, the cartridge sensor 157, the pair of drawer gate opening and closing sensors 159a and 159b, and the pair of medicine-dispensing-tray gate opening and closing sensors 160a and 160b are illustrated in FIG. 15.

To the input port of the above CPU, a home position (HP) sensor 99 that is used for a home position (HP) sensor X to detect the home position (HP) of the X-axis direction conveyance unit 91 in the carriage 50, an HP sensor 109 that is used for an HP sensor Y to detect the home position (HP) of the Y-axis direction conveyance unit 101 in the carriage 50, and an HP sensor 119 that is used for an HP sensor Z to detect the home position (HP) of the Z-axis direction conveyance unit 111 in the carriage 50 are electrically connected. Further, to the input port of the CPU, a home position (HP) sensor 158 for an HP sensor P that detects the home position (HP) of the pair of suction pads 52 of the suction device 51 in the carriage 50 is electrically connected.

The upper QR code reader 66 that is an example of the medication-related information reader unit 65 or an upper reader unit 66a and the lower QR code reader 67 that is an example of the medication-related information reader unit 65 or a lower reader unit 67a, each of which is provided for the carriage 50, are electrically connected to the input port of the CPU. Further, to the input port of the CPU, a cartridge sensor 70 that is an example of a container sensor and detects the attachment and detachment of the cartridge 10 to the housing 199 of the medicine dispensing apparatus 200 is electrically connected. The container sensor and the cartridge sensor 70 will be described later in detail.

Moreover, each one of the drive motor 95 for the X-axis direction conveyance unit 91, the drive motor 105 for the Y-axis direction conveyance unit 101, the drive motor 115 for the Z-axis direction conveyance unit 111, and the drive motor 63 used to change the posture of the suction pad 52 is electrically connected to the output port of the CPU through various types of motor drivers X, Y, Z, and P. To the output port of the CPU, the negative-pressure generator 45 that is an example of an ejector valve and an actuator used for the negative-pressure generator is electrically connected through a driver for a negative-pressure generator.

To the output port of the CPU, a notification unit 154 may be electrically connected. The notification unit 154 reports what sort of state or conditions the components or elements of the medicine dispensing apparatus 200 are in by means of, for example, the light emitted from a light-emitting diode (LED) and the sound or vibration, including voice. Moreover, the notification unit 154 may be provided with, for example, a loudspeaker or a light that indicates that the medicines are to be taken so that the staff or the like away from the medicine dispensing apparatus 200 can be notified of such a time of medication.

The external medicine information is also input to the CPU through an input and output (I/O) interface, and is stored in the built-in memory 152. For example, the external medicine information is used for the allocation of medicines to patients who take medicines. For example, the LEDs 25al to 25a5, 25b1 to 25b5, 25cl to 25c5, and 25d1 to 25d5 of the drawer 80 may be electrically connected to each other.

Once the input data from the touch panel 151 and various kinds of signals from various types of sensors or the HP sensors 99, 109, 119, and 158 are input to the CPU, a command signal is newly output from the CPU. In other words, the CPU according to the present embodiment outputs a command signal used to control the audio device or the optical device of the display device of the touch panel 151 including the above notification unit 154, the LEDs 25al to 25a5, 25b1 to 25b5, 25cl to 25c5, and 25d1 to 25d5, the negative-pressure generator 45, the drive motor 63, the drive motor 95, the drive motor 105, the drive motor 115, or the multiple drives that correspond to the multiple LEDs.

The HP sensor 158 for the HP sensor P and the drive motor 63 that outputs power through the motor driver P are used to control or drive the mechanism for moving the suction device upward and downward. The CPU according to the present embodiment has a function to execute various kinds of control operations as will be described later in detail in the following description or the flowchart of the controlling processes.

How the attachment and detachment (or loading and unloading) of the cartridge 10 is detected using a sensor is described below.

FIG. 16A and FIG. 16B are schematic diagrams of a cartridge sensor 70 that detects the attachment and detachment (or loading and unloading) of the cartridge 10.

As illustrated in FIG. 16A, a cartridge 10X that is an object to be detected is assumed, and such a cartridge is detected by an optical sensor such as a reflective photosensor that is an example of the container sensor.

The cartridge sensor 70 that includes an optical sensor emits detection lights 71a from a light emitter 71, and receives reflection light 72a from that cartridge 10X at a photoreceptor 73 when the cartridge 10X is present. By so doing, the presence or absence of the cartridge 10X, which is an object to be detected, can be detected. By contrast, when there is no cartridge 10X, which is an object to be detected, as illustrated in FIG. 16B, the reflection light of the detection light 71a does not enter the photoreceptor 73. Due to such a configuration, the absence of the cartridge 10X, which is an object to be detected, can be detected.

As illustrated in FIG. 16C, the cartridge sensor 70 with such an optical sensor as above is fitted and fixed to the cartridge tray 20 having, for example, a fitting plate 74 therebetween. Due to such a configuration, the attachment or detachment (or loading and unloading) of the cartridge 10 can be detected. When the cartridge sensor 70 is attached to the cartridge tray 20, the cartridge sensor 70 is fitted to the cartridge tray 20 using the fitting plate 74 so as not to interfere with, for example, the carriage 50 at the time of the QR-code reading operation using the upper reader unit 66a of the upper QR code reader 66 illustrated in FIG. 10 or FIG. 13.

The cartridge sensor 70 is not limited to the above optical sensor, and may use a distance sensor to check the changes in the distance from the cartridge 10. Due to such a configuration, the attachment or detachment (or loading and unloading) of the cartridge 10 can be detected. Alternatively, the cartridge sensor 70 may use a weight sensor to detect changes in the weight of the cartridge 10. Due to such a configuration, the attachment and detachment (or loading and unloading) of the cartridge 10 can be detected. The cartridge sensor 70 is not limited to the optical sensor, the distance sensor, or the weight sensor as described above, and may be, for example, a push switch that contacts the cartridge 10 to detect the attachment or detachment of the cartridge 10.

An example in which the attachment and detachment (or loading and unloading) of the cartridge 10 is detected using the cartridge sensor 70, which is composed of an optical sensor and is provided for each one of the cartridges 10, is described below with reference to FIG. 17A, FIG. 17B, FIG. 17C, FIG. 17D, and FIG. 18.

FIG. 17A and FIG. 17B are diagrams illustrating the cartridge tray 20 to which the cartridge 10 is not yet attached.

FIG. 17C and FIG. 17D are diagrams illustrating the cartridge tray 20 to which the cartridge 10 is attached.

FIG. 17A is a sectional view of the cartridge tray 20 to which the cartridge 10 is not yet attached and elements around the cartridge tray 20.

FIG. 17B is a bottom view of the cartridge tray 20 to which the cartridge 10 is not yet attached.

FIG. 17C is a sectional view of the cartridge 10, the cartridge tray 20 to which the cartridge 10 is not yet attached, and elements around the cartridge tray 20.

FIG. 17D is a bottom view of the cartridge tray 20 to which the cartridge 10 is attached.

FIG. 18 is a bottom view of the multiple cartridge trays 20 on each of which the cartridge sensor 70 is mounted.

As illustrated in FIG. 17C and FIG. 17D, when the cartridge 10 is attached and set on the cartridge tray 20, the cartridge sensor 70 mounted on the outer bottom face of the cartridge tray 20 detects the bottom face of the cartridge 10. Accordingly, it is possible to monitor that the cartridge 10 is attached and set on the cartridge tray 20.

As described above, by arranging the cartridge sensor 70 on the cartridge tray 20, the loading or unloading of each cartridge 10 on the cartridge tray 20 can be checked. The multiple cartridge trays 20 may be combined together as illustrated in FIG. 18.

In the present embodiment described with reference to FIG. 18, the loading or unloading of each cartridge 10 is detected, and the cartridge 10 with changes due to an operation can be monitored with a high degree of accuracy. On the other hand, as a sensor is provided for each one of the cartridges 10, the cost increases, and electrical wiring for a container sensor such as the cartridge sensor 70 has to be done for each one of the cartridge sensors 70.

Before describing the control structure of the medicine dispensing apparatus 200, the control structure of a medication support system in the related art is described below. In the related art, a plurality of medicine dispensing apparatuses and a control device including a personal computer (PC) that is connected to and can communicate with those medicine dispensing apparatuses are provided.

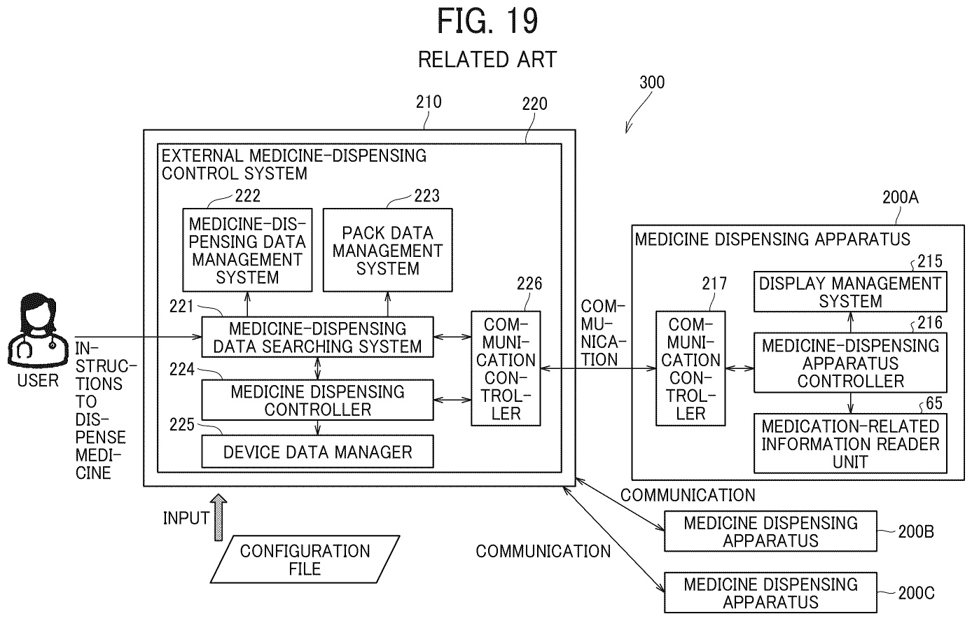

FIG. 19 is a diagram illustrating the control blocks of a medication support system 300 according to the related art.

As illustrated in FIG. 19, the medication support system 300 in the related art includes a plurality of medicine dispensing apparatuses 200A, 200B, and 200C having a basic configuration equivalent to that of the above-described medicine dispensing apparatus 200 and a control device 210 that is connected to and can communicate with those medicine dispensing apparatuses 200A, 200B, and 200C. The basic configuration of the multiple medicine dispensing apparatuses 200A, 200B, and 200C is all equivalent to that of the above-described medicine dispensing apparatus 200, but as will be described later in detail, their medicine dispensing operations are different from each other.

Typically, the control device 210 is configured by a personal computer (PC), and includes five hardware components. In other words, the control device 210 is provided with, for example, a control device, a processor, a memory, an input device, and an output device. The above control device of the control device 210 is provided with a central processing unit (CPU), and executes a program or gives instructions to other devices.

The above processor of the control device 210 executes a program or performs computation. The above memory of the control device 210 is provided with, for example, a main memory and an auxiliary memory, and stores data such as programs or texts.

The above input device of the control device 210 includes, for example, a mouse, a keyboard, and a microphone, and sends data or instructions to the computer. The above output device of the control device 210 includes, for example, a display, a printer, and a loudspeaker, and outputs the data from the computer.

The control device 210 in the related art manages the control data used to control a series of medicine dispensing operations in the medicine dispensing apparatuses 200A, 200B, and 200C, where the medicine package 2 stored in the cartridge 10 is conveyed and dispensed to corresponding one of the subdivision boxes 34 placed on the medicine dispensing tray 30. More specifically, the control device 210 stores the configuration data used to configure the control data of the medicine dispensing operation of each of the medicine dispensing apparatuses 200A, 200B, and 200C, and sends the corresponding control data to each of the medicine dispensing apparatuses 200A, 200B, and 200C. In the medicine dispensing apparatuses 200A, 200B, and 200C, the medicine dispensing operation is controlled based on various kinds of control data sent from the control device 210.

More specifically, the control device 210 is provided with an external medicine-dispensing control system 220 that is implemented by hardware components. Typically, the external medicine-dispensing control system 220 includes a medicine-dispensing data searching system 221, a medicine-dispensing data management system 222, a pack data management system 223, a medicine dispensing controller 224, a device data manager 225, and a communication controller 226. In the external medicine-dispensing control system 220 in the related art, some of the control systems internally provided for a medicine dispensing apparatus according to a comparative example are transferred to the control device 210, and varying control data is managed by every medicine dispensing apparatus.

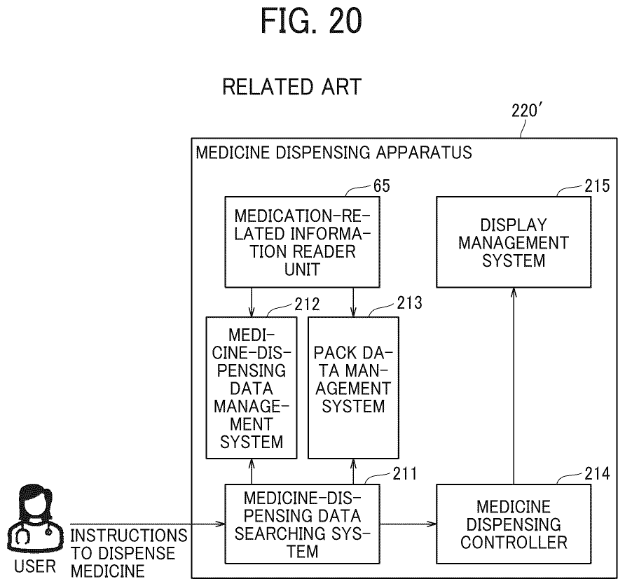

FIG. 20 is a diagram illustrating the control blocks of a medicine dispensing apparatus 200′ according to the related art.

In the medicine dispensing apparatus 200′ in the related art, when the QR CODE attached to the cartridge 10 or the medicine package 2 is read by the medication-related information reader unit 65 that includes the upper QR code reader 66 and the lower QR code reader 67, as illustrated in FIG. 20, the data that is obtained from the QR CODE is reported to the pack data management system 213 of the medicine dispensing apparatus 200′.

When the QR CODE attached to the subdivision box 34 is read, the data that is obtained from the QR CODE is reported to the medicine-dispensing data management system 212 of the medicine dispensing apparatus 200′. Each one of the pack data management system 213 and the medicine-dispensing data management system 212 analyzes or processes the QR code data sent from the medication-related information reader unit 65 when necessary, and keeps the data in an appropriate manner.

When a user gives instructions to dispense medicine, such instructions trigger the medicine-dispensing data searching system 211 in the medicine dispensing apparatus 200′ according to the related art to send a data query to the medicine-dispensing data management system 212 and the pack data management system 213. Accordingly, a combination of the position of the cartridge 10 where medicines to be dispensed such as the medicine packages 2 are stored and the position of the subdivision box 34 to which those medicines such as the medicine packages 2 are to be dispensed is specified. The medicine-dispensing data searching system 211 notifies the medicine dispensing controller 214 of the specified combination.

The medicine dispensing controller 214 performs an operation where the medicine package 2 is picked up from desired one of the cartridges 10 specified in the combination sent from the medicine-dispensing data searching system 211 and the picked-up medicine package 2 is dispensed to the subdivision box 34 specified in the sent combination. The display management system 215 notifies a user of the status or condition of the medicine dispensing apparatus 200′ by displaying, for example, a message indicating that medicines are being dispensed, a message indicating that the medicine-dispensing operation is completed, and a message indicating an error.

In the medication support system 300 in the related art, the medicine-dispensing data searching system 221 that serves as the medicine-dispensing data searching system 211, the medicine-dispensing data management system 222 that serves as the medicine-dispensing data management system 212, the pack data management system 223 that serves as the pack data management system 213, and the medicine dispensing controller 224 that partially serves as the medicine dispensing controller 214, which are the control systems internally provided for the medicine dispensing apparatus 200′, are transferred to the external medicine-dispensing control system 220 of the control device 210. In the medication support system 300 in the related art, the external medicine-dispensing control system 220 that is transferred to the control device 210 is shared by the multiple medicine dispensing apparatuses 200A, 200B, and 200C.

More specifically, in the medicine dispensing apparatuses 200A, 200B, and 200C, as illustrated in FIG. 9A and FIG. 9B, the upper QR code reader 66 and the lower QR code reader 67 that make up the medication-related information reader unit 65 are provided for the carriage 50. The carriage 50 moves close to one of the multiple cartridges 10 that stores a medicine pack such as the medicine package 2 and the bound packages 2A, and the QR CODE that indicates medication-related information 6c can be read by the upper reader unit 66a of the upper QR code reader 66.

In the case of a medicine dispensing apparatus where the medication-related information 6c is displayed on the surface of the medicine package 2 as illustrated in FIG. 5A and FIG. 5B, the QR CODE is read by the upper reader unit 66a of the upper QR code reader 66 through the pack pickup slot 17 as illustrated in FIG. 10. In the case of a medicine dispensing apparatus where the medication-related information 6c is displayed on the left support portion 13 on the bottom wall of one of the multiple cartridges 10 as illustrated in FIG. 13,

The QR CODE that indicates the medication-related information 6c, which is attached to and displayed on the pack pickup slot 17, is read by the upper reader unit 66a of the upper QR code reader 66.

In some medicine dispensing apparatuses, as illustrated in FIG. 12A, the QR CODE that indicates the medication-related information 6c is read by the lower reader unit 67a of the lower QR code reader 67 while the carriage 50 is moving to a position above the desired one of the multiple subdivision boxes 34 of the medicine dispensing tray 30 with one of the multiple medicine packages 2 picked up from one of the multiple cartridges 10 held. Due to the configurations as described above, the data that has been read by the upper QR code reader 66 or the lower QR code reader 67 of the medicine dispensing apparatuses 200A, 200B, and 200C is sent to the pack data management system 223 in the external medicine-dispensing control system 220 of the control device 210 through the communication controller 217.

As the carriage 50 is provided with the upper QR code reader 66 and the lower QR code reader 67 of the medicine dispensing apparatuses 200A, 200B, and 200C, the name of a patient who takes medicines and the current position of the cartridge 10 in which the medicine pack to be taken by the patient who takes medicines is stored can be detected by the movement of the carriage 50. In other words, when the QR CODE on one of the multiple cartridges 10 is read by the upper QR code reader 66 to obtain the position coordinates of the cartridge 10 in the medicine dispensing apparatus corresponding to the current position of the cartridge 10, the position coordinates of the carriage 50 corresponding to the current position of the cartridge 10 can be linked to the QR CODE that indicates the medication-related information 6c. In the position coordinates of the cartridge, for example, X, Y, and Z indicate the rows, columns, and stages, respectively.

In a similar manner to the above, by the movement of the carriage 50 in the medicine dispensing apparatuses 200A, 200B, and 200C, the name of a patient who takes medicines and the current position of the subdivision box 34 to which the medicine pack to be taken by the patient who takes medicines is to be dispensed can be detected. In other words, when the QR CODE of the label 7 attached to the subdivision box 34 is read by the lower QR code reader 67 to obtain the position coordinates of the subdivision box 34 in the medicine dispensing apparatus corresponding to the current position of the subdivision box 34, the position coordinates of the carriage 50 corresponding to the current position of the subdivision box 34 can be linked to the QR CODE that indicates the medication-related information 6c. In the position coordinates of the subdivision box, for example, X, Y, and Z indicate the rows, columns, and stages, respectively.

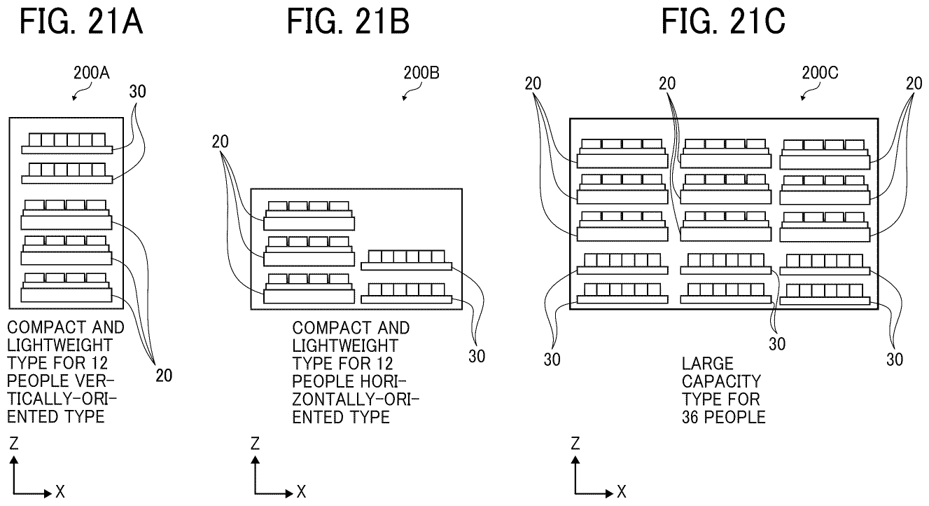

There are medicine dispensing apparatuses whose configuration or structure for the medicine dispensing operation is different depending on, for example, the difference in the model or type. For example, as illustrated in FIG. 21A, the medicine dispensing apparatus 200A is of a vertical type for a small number of people (for twelve people in the example described with reference to FIG. 21A) where the cartridge trays 20 and the medicine dispensing trays 30 are vertically aligned in three stages and two stages, respectively.

In a similar manner, as illustrated in FIG. 21B, the medicine dispensing apparatus 200B is of a horizontally-oriented type for a small number of people (for twelve people in the example described with reference to FIG. 21A) where the cartridge trays 20 and the medicine dispensing trays 30 are horizontally aligned in three stages and two stages, respectively. In the medicine dispensing apparatus 200C for a large number of people (for thirty-six people in the example illustrated in FIG. 21C) as illustrated in FIG. 21C, the number of the cartridge trays 20 and the number of the medicine dispensing trays 30 are different from a model for a small number of people, and the positions of the cartridge trays 20 and the medicine dispensing trays 30 are reversed compared with the vertical type described above with reference to FIG. 21A.

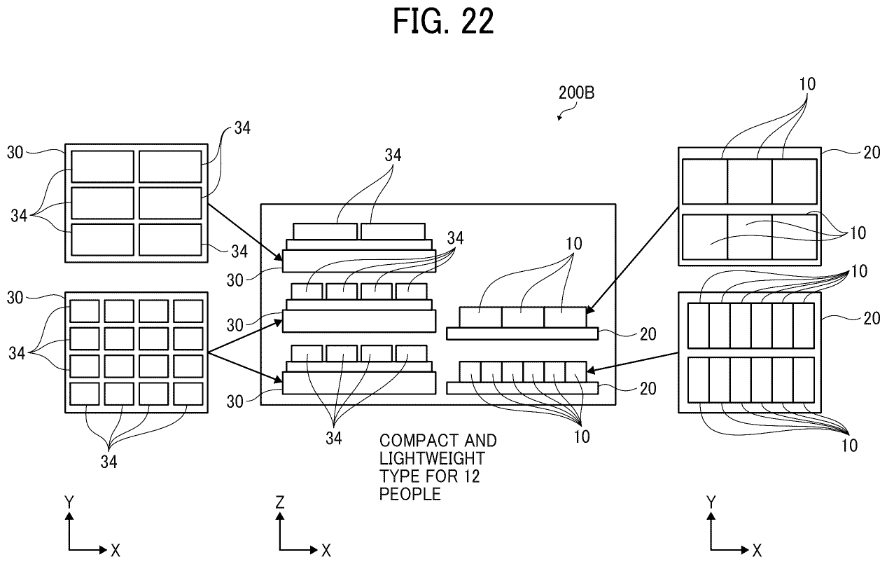

Even if a medicine dispensing apparatus of the same model is adopted, the type (or structure or configuration) of the cartridge trays 20 or the medicine dispensing trays 30 to be placed therein may vary depending on the conditions such as the type or size of the medicine packages. Further, as illustrated in FIG. 22, the cartridge trays 20 or the medicine dispensing trays 30 of varying configurations or types may be placed in a single medicine dispensing apparatus in a mixed manner.

As described above, the configuration or structure for the medicine dispensing operation varies in each of the medicine dispensing apparatuses depending on, for example, differences among the models of a medicine dispensing apparatus and differences among the types of the cartridge tray 20 or the medicine dispensing tray 30. For this reason, in a comparative example, control systems dedicated to each of the medicine dispensing apparatuses are to be provided. The number of dedicated control systems to be produced may become enormous depending on the combinations of, for example, differences among the models of a medicine dispensing apparatus and differences among the types of the cartridge tray 20 or the medicine dispensing tray 30, and the cost of development for control systems or the cost of management or maintenance for control systems increases.

By contrast, when a control system shared by among a plurality of medicine dispensing apparatuses of varying configurations is adopted in order to reduce the number of dedicated control systems to be produced, it becomes difficult to achieve best-suited control in each of the medicine dispensing apparatuses, and the quality of medicine dispensing operation in each medicine distribution device may become poor. Further, when a medicine dispensing apparatus having a dedicated configuration is to be provided, it is necessary to make up a dedicated control system from scratch, and it becomes difficult to provide a medicine dispensing apparatus speedily.

The medication support system 300 in the related art is to solve or address such technical problems related to quality, cost, and delivery (QCD). In other words, in the medication support system 300 according to the present embodiment, the control device 210 manages the control data used to control the medicine dispensing operations in the multiple medicine dispensing apparatuses 200A, 200B, and 200C whose configuration or structure for the medicine dispensing operation is different. In other words, the control device 210 sends the corresponding control data to each of the multiple medicine dispensing apparatuses 200A, 200B, and 200C such that the medicine dispensing apparatuses 200A, 200B, and 200C can control the medicine dispensing operation based on varying control data.

The device data manager 225 of the control device 210 stores a configuration file including the configuration data used to configure the control data for each of the multiple medicine dispensing apparatuses 200A, 200B, and 200C in the memory in association with the multiple medicine dispensing apparatuses 200A, 200B, and 200C. Accordingly, some of the control systems of the multiple medicine dispensing apparatuses 200A, 200B, and 200C can be transferred to the external medicine-dispensing control system 220 of the control device 210, and can be integrated into the control device 210. In regard to the control for the medicine dispensing operation related to the configuration or structure that varies among the multiple medicine dispensing apparatuses 200A, 200B, and 200C, control suited to each one of the medicine dispensing apparatuses 200A, 200B, and 200C is implemented based on the items of control data that are configured according to the items of configuration data of the medicine dispensing apparatuses 200A, 200B, and 200C.

In order to achieve such functions, the configuration files that include the configuration data of the medicine dispensing apparatuses 200A, 200B, and 200C are read and stored in the external medicine-dispensing control system 220 of the control device 210. For example, the configuration file may be of any file format such as a file format used for spreadsheet software or the like, comma separated value (CSV) format, and plaintext.

A plurality of items of configuration data associated with medicine dispensing apparatuses may be included in a single configuration file, or the same type of configuration data of a plurality of medicine dispensing apparatuses may be included in a single configuration file. Alternatively, a plurality of items of configuration data associated with medicine dispensing apparatuses may be included in separate configuration files on a configuration-data by configuration-data basis.

According to the medication support system 300 in the related art, the control systems of the multiple medicine dispensing apparatuses 200A, 200B, and 200C can be simplified. Even if the model varies or the cartridge tray 20 or the medicine dispensing tray 30 varies in the medicine dispensing apparatuses, medicine dispensing operations such as a reading operation for the medication-related information, an operation in which medicine packages are picked up from the cartridge 10, and an operation in which medicine packages are dispensed and laid out in one of the subdivision boxes 34 of the medicine dispensing tray 30 are performed as desired based on various kinds of control data sent from the control device 210.

When instructions to dispense medicine are input to the control device 210 by a user in the medication support system 300 in the related art, firstly, the medicine-dispensing data searching system 221 in the external medicine-dispensing control system 220 of the control device 210 determines whether to update the medication-related information in the medicine dispensing apparatus such as the medicine dispensing apparatus 200A to which instructions to dispense medicine have been given. When it is determined in this determination that the medication-related information is to be updated, the medicine-dispensing data searching system 221 instructs the medicine dispensing controller 224 to update the medication-related information.

In response to instructions to update the medication-related information, the medicine dispensing controller 224 refers to the information about the medicine dispensing apparatus 200A stored in the device data manager 225, and instructs the medicine dispensing apparatus 200A to perform the reading operation for the medication-related information through the communication controller 226. What is to be controlled in the reading operation for the medication-related information in the multiple medicine dispensing apparatuses 200A, 200B, and 200C varies depending on differences in the configuration or structure of each of the medicine dispensing apparatuses 200A, 200B, and 200C.

More specifically, when the QR CODE, which is attached to one of the cartridges 10 on the cartridge tray 20 or attached to the medicine package 2 stored in one of the cartridges 10, to indicate the medication-related information 6c is read, how the carriage 50 provided with the medication-related information reader unit 65 including the upper QR code reader 66 and the lower QR code reader 67 moves (for example, to what position the carriage 50 is to be moved and the carriage 50 is to be moved in what order) varies depending on the differences in the configuration or structure of the cartridge trays 20 (for example, the number or positions of the cartridge trays 20 in the medicine dispensing apparatus, the number or arrangement of the cartridges 10 on the multiple cartridge trays 20, and the installation locations of the QR CODEs (or the positions at which the QR CODEs are to be read).

When the QR CODE attached to one of the subdivision boxes 34 on the medicine dispensing tray 30 to indicate the medication-related information 6c is to be read, how the carriage 50 provided with the medication-related information reader unit 65 including the upper QR code reader 66 and the lower QR code reader 67 moves (for example, to what position the carriage 50 is to be moved and the carriage 50 is to be moved in what order) varies depending on the differences in the configuration or structure of the medicine dispensing tray 30 (for example, the number or positions of the medicine dispensing trays 30 in the medicine dispensing apparatus, the number or arrangement of the subdivision boxes 34 on the multiple medicine dispensing trays 30, and the installation locations of the QR CODEs (or the positions at which the QR CODEs are to be read).

The configuration file of each of the medicine dispensing apparatuses 200A, 200B, and 200C includes the information about the configuration or structure of each one of the medicine dispensing apparatuses 200A, 200B, and 200C (medicine dispensing apparatus 200), which indicates the configuration or structure of the cartridge trays 20 and the configuration or structure of the medicine dispensing trays 30, and the configuration data on a medicine dispensing apparatus, which includes, for example, the addresses of counterpart communication terminals for each of the medicine dispensing apparatuses. In response to instructions to update the medication-related information, the medicine dispensing controller 224 refers to the configuration file that corresponds to the medicine dispensing apparatus 200A indicated by those instructions, and generates control data that indicates what is to be controlled in the reading operation for the medication-related information in the medicine dispensing apparatus 200A, based on the information about the configuration or structure of the medicine dispensing apparatus 200A. The medicine dispensing controller 224 instructs the medicine dispensing apparatus 200A to perform the reading operation for the medication-related information through the communication controller 226 based on the generated control data.

The medicine dispensing apparatus 200A receives the instructions on the reading operation for the medication-related information, which include the control data for reading operations, through the communication controller 217. The medicine-dispensing apparatus controller 216 of the medicine dispensing apparatus 200A controls, for example, various kinds of motors in accordance with the received control data to move the carriage 50 to a desired position.

For example, when instructions are received on the reading operation for the QR CODE attached to one of the cartridges 10 on the cartridge tray 20 or the medicine package 2 stored in one of the cartridges 10 to indicate the medication-related information 6c, for example, various kinds of motors are controlled in accordance with the received control data to move the carriage 50 to a desired position, and the QR CODE is read by the medication-related information reader unit 65 on the carriage 50 including the upper QR code reader 66 and the lower QR code reader 67. For example, when instructions are received on the reading operation for the QR CODE attached to one of the subdivision boxes 34 on the medicine dispensing tray 30 to indicate the medication-related information 6c, for example, various kinds of motors are controlled in accordance with the received control data to move the carriage 50 to a desired position, and the QR CODE is read by the medication-related information reader unit 65 on the carriage 50 including the upper QR code reader 66 and the lower QR code reader 67.

The medicine-dispensing apparatus controller 216 obtains the medication-related information from the QR CODE read by the medication-related information reader unit 65, and sends the obtained medication-related information to the control device 210 through the communication controller 217. This medication-related information is received by the external medicine-dispensing control system 220 through the communication controller 226 of the control device 210, and is managed by the medicine-dispensing data management system 222 or the pack data management system 223.

After the medication-related information has been updated as above or after it is determined that the medication-related information is not to be updated as above, the medicine-dispensing data searching system 221 sends a data query to the medicine-dispensing data management system 212 and the pack data management system 213 about the medicine dispensing apparatus 200A to which instructions to dispense medicine have been given. Accordingly, the medicine-dispensing data searching system 221 can specify a combination of the position of the cartridge 10 where medicines to be dispensed such as the medicine packages 2 are stored and the position of the subdivision box 34 to which those medicines such as the medicine packages 2 are to be dispensed. The medicine-dispensing data searching system 211 notifies the medicine dispensing controller 224 of the specified combination.

The medicine dispensing controller 224 of the control device 210 gives instructions to the medicine dispensing apparatus 200A where medicines are to be dispensed. Accordingly, the medicine package 2 is picked up from desired one of the cartridges 10 specified in the combination sent from the medicine-dispensing data searching system 221, and the picked-up medicine package 2 is dispensed to the subdivision box 34 specified in the sent combination. In a similar manner to what is to be controlled in the reading operation for the medication-related information as above, what is to be controlled in the picking-up operation for the medicine package 2 or the placing operation for the medicine package 2 in the multiple medicine dispensing apparatuses 200A, 200B, and 200C also varies depending on differences in the configuration or structure of each of the medicine dispensing apparatuses 200A, 200B, and 200C.

More specifically, when desired one of the multiple medicine packages 2 is to be picked up from one of the multiple cartridges 10, how the carriage 50 moves (for example, to what position the carriage 50 is to be moved and the carriage 50 is to be moved in what order) varies depending on the differences in the configuration or structure of the cartridge trays 20 (for example, the number or positions of the cartridge trays 20 in the medicine dispensing apparatus, the number or arrangement of the cartridges 10 on the multiple cartridge trays 20, a position at which desired one of the multiple medicine packages 2 is picked up from the cartridge 10, and a method of picking up desired one of the multiple medicine packages 2 from the cartridge 10).

When the picked-up medicine package 2 is dispensed and laid out to the subdivision box 34, how the carriage 50 moves (for example, to what position the carriage 50 is to be moved and the carriage 50 is to be moved in what order) varies depending on the differences in the configuration or structure of the medicine dispensing tray 30 (for example, the number or positions of the medicine dispensing trays 30 in the medicine dispensing apparatus, the number or arrangement of the subdivision boxes 34 on the multiple medicine dispensing trays 30, a position at which the medicine package 2 is placed into the subdivision box 34, and a method of placing the medicine package 2 into the subdivision box 34).

As described above, the configuration file of each of the medicine dispensing apparatuses 200A, 200B, and 200C includes the information about the configuration or structure of each one of the medicine dispensing apparatuses 200A, 200B, and 200C (medicine dispensing apparatus 200), which indicates the configuration or structure of the cartridge trays 20 and the configuration or structure of the medicine dispensing trays 30, and the configuration data on a medicine dispensing apparatus, which includes, for example, the addresses of counterpart communication terminals for each of the medicine dispensing apparatuses. The medicine dispensing controller 224 refers to the configuration file that corresponds to the medicine dispensing apparatus 200A indicated by the instructions to dispense medicines given from a user, and generates control data that indicates what is to be controlled in the picking-up operation for the medicine package 2 or the placing operation for the medicine package 2 in the medicine dispensing apparatus 200A, based on the information about the configuration or structure of the medicine dispensing apparatus 200A. The medicine dispensing controller 224 instructs the medicine dispensing apparatus 200A to perform the picking-up operation for the medicine package 2 and the placing operation for the medicine package 2 based on the generated control data, through the communication controller 226.

The medicine dispensing apparatus 200A receives instructions for the picking-up operation for the medicine package 2 and the placing operation for the medicine package 2, which include the control data for the picking-up operation and the placing operation, through the communication controller 217. The medicine-dispensing apparatus controller 216 of the medicine dispensing apparatus 200A controls, for example, various kinds of motors in accordance with the received control data to move the carriage 50 to a desired position.

More specifically, when desired one of the multiple medicine packages 2 is to be picked up from the cartridge 10, for example, various kinds of motors are controlled in accordance with the received control data for the picking-up operation to move the carriage 50 to a desired position, and desired one of the multiple medicine packages 2 is picked up from targeted one of the multiple cartridges 10. Then, for example, various kinds of motors are controlled in accordance with the received control data for the placing operation to move the carriage 50 to a desired position, and the medicine package 2 is placed in the desired one of the subdivision boxes 34.

Then, the medicine dispensing apparatus 200A sends the obtained medication-related information to the control device 210 indicating, for example, the result of the instructed medicine dispensing operation as to whether the operation has been successfully done or ended in failure, through the communication controller 217. The result of the medicine dispensing operation is received by the external medicine-dispensing control system 220 through the communication controller 226 of the control device 210, and the above series of operations is repeated where appropriate.

In the medication support system 300 in the related art, the medicine-dispensing data searching system 221, the medicine-dispensing data management system 222, and the pack data management system 223 are transferred from the medicine dispensing apparatus to the control device 210. However, no limitation is indicated thereby, and some of these systems may be provided for the medicine dispensing apparatus. By transferring the medicine-dispensing data searching system 221, the medicine-dispensing data management system 222, and the pack data management system 223 from the medicine dispensing apparatus to the control device 210 as in the related art, the control systems of the multiple medicine dispensing apparatuses 200A, 200B, and 200C can be simplified, and the above-described technical problems related to quality, cost, and delivery (QCD) could be solved or addressed.

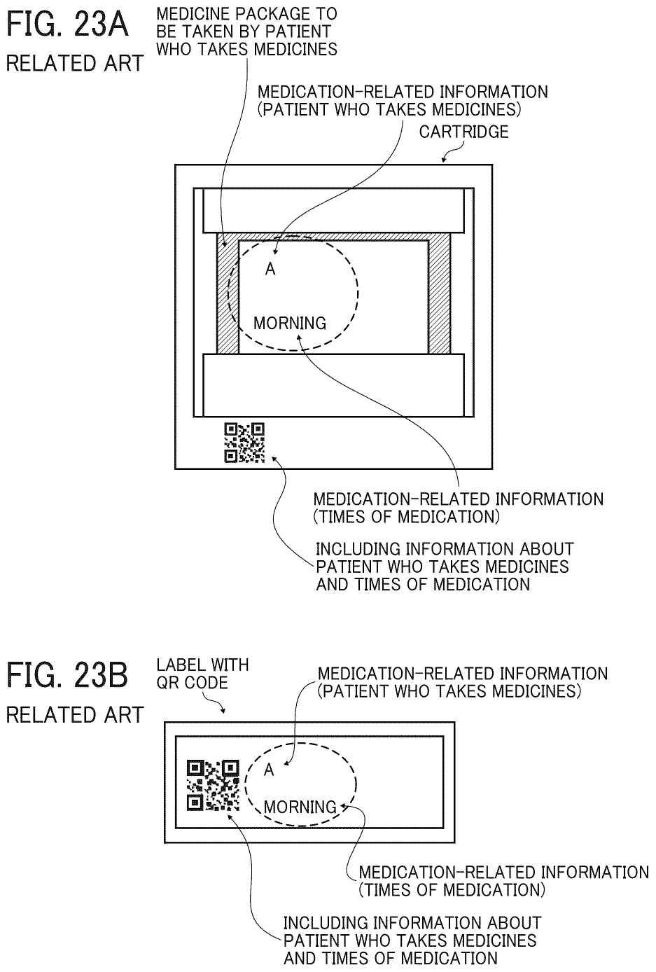

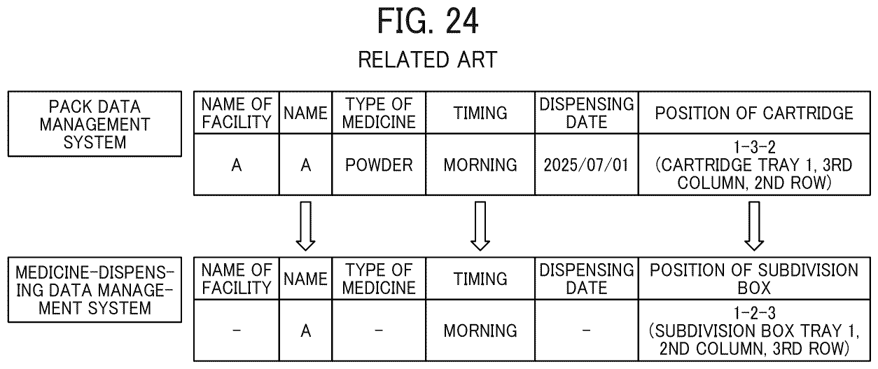

In the control structure of the medication support system in the related art, as illustrated in FIG. 23A, FIG. 23B, and FIG. 24, the medication-related information included in the QR CODEs on the cartridges is checked against the medication-related information included in the QR CODEs on the subdivision boxes in the medicine dispensing tray, and the positions of the cartridges are linked to the positions of the subdivision boxes in the medicine dispensing tray at a ratio of 1:1 so as to achieve complete match in the names of patients who take medicines and the times of medication. By so doing, the subdivision box to which the medicine packages 2 are to be dispensed is determined.

In other words, in the related art, the data obtained by scanning and reading the QR CODE on the cartridges is stored in the pack data management system, and the data obtained by scanning and reading the QR CODEs on the subdivision boxes in the medicine dispensing tray is stored in the medicine-dispensing data management system. The medicine-dispensing data management system checks the name of a patient who takes medicines and the times of medication, and the positions of the cartridges 10 are linked to the positions of the subdivision boxes 34 in the medicine dispensing tray 30 at a ratio of 1:1

By so doing, the subdivision box to which medicines are to be dispensed is determined.

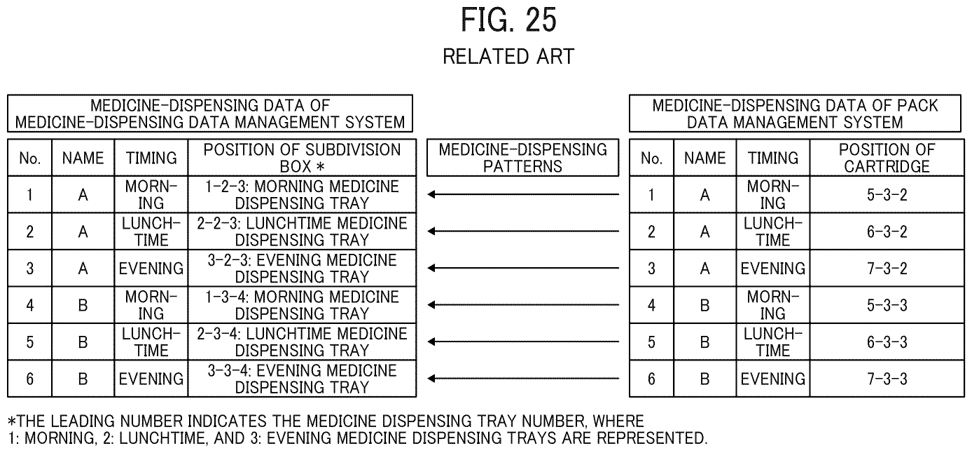

In the related art, as in the example illustrated in FIG. 25, the medicine dispensing data of the medicine-dispensing data management system is checked against the medicine dispensing data of the pack data management system, and medicine-dispensing patterns are determined with combinations in which the names of patients who take medicines and the times of medication are matched. The linkage between the position of the cartridge and the position of the subdivision box in the medicine dispensing tray in a one-to-one relationship. Due to such configurations as described above, the number of the subdivision boxes in the medicine dispensing tray and the number of the cartridges have to be equal to each other in order for all the medicine-dispensing patterns to operate under normal operating conditions.

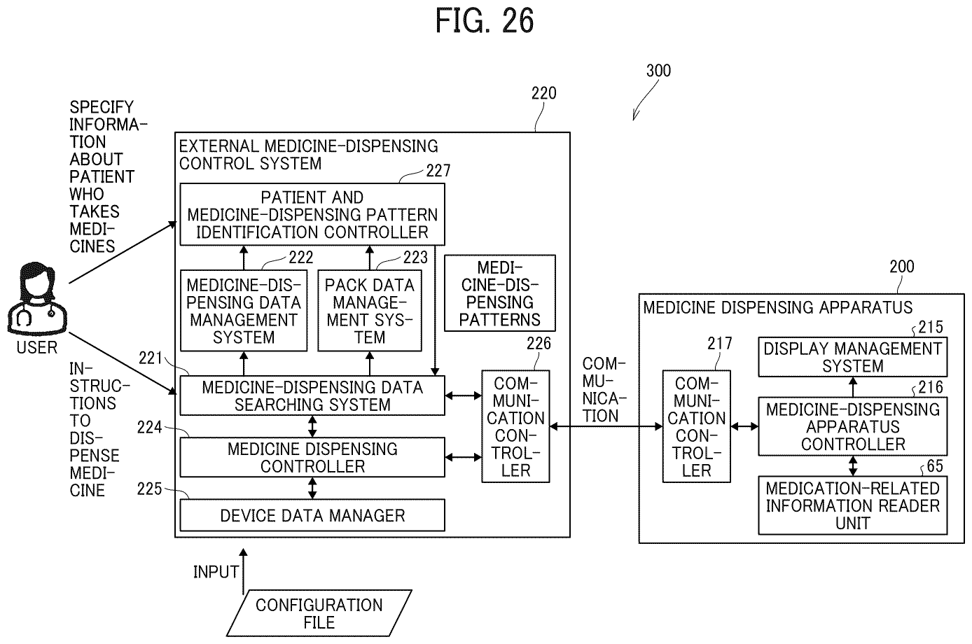

Compared with the configuration in the related art (see FIG. 19), as illustrated in FIG. 26, the patient and medicine-dispensing pattern identification controller 227 is added to the control structure of the medication support system 300 according to the present embodiment. The information about the patient who takes the medicines is given from a user to the patient and medicine-dispensing pattern identification controller 227, and instructions to dispense medicine are given to the medicine-dispensing data searching system 221.

The patient and medicine-dispensing pattern identification controller 227 reads the medicine dispensing data stored in each of the medicine-dispensing data management system 222 and the pack data management system 223, and identifies the medicine-dispensing patterns based on those two kinds of medicine dispensing data. The information about the result of the above identification is given to the medicine-dispensing data searching system 221.

Based on the received medicine-dispensing patterns, the medicine-dispensing data searching system 221 instructs the medicine dispensing apparatus 200 to perform a medicine dispensing operation through the communication controller 226. The medicine dispensing apparatus 200 and its medicine dispensing operation are equivalent to those of the related art described above with reference to FIG. 19.

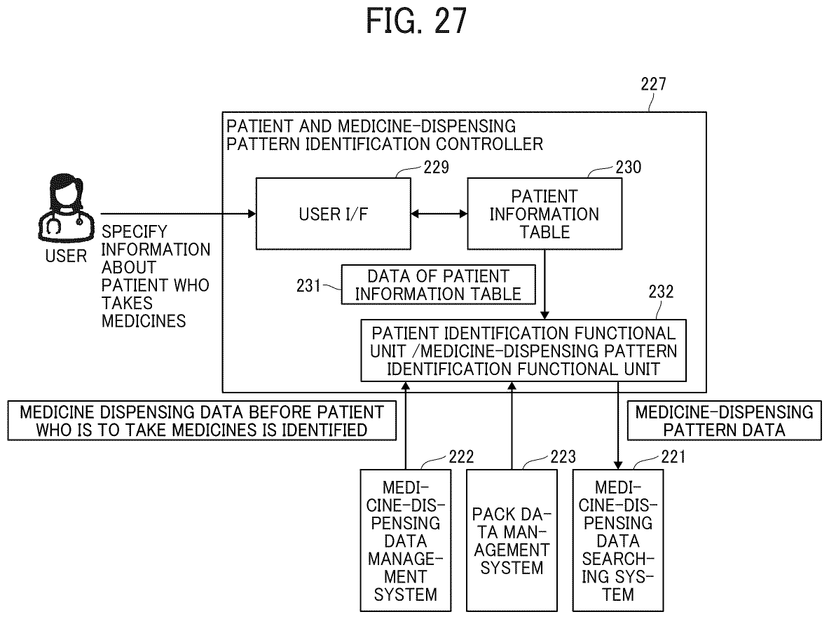

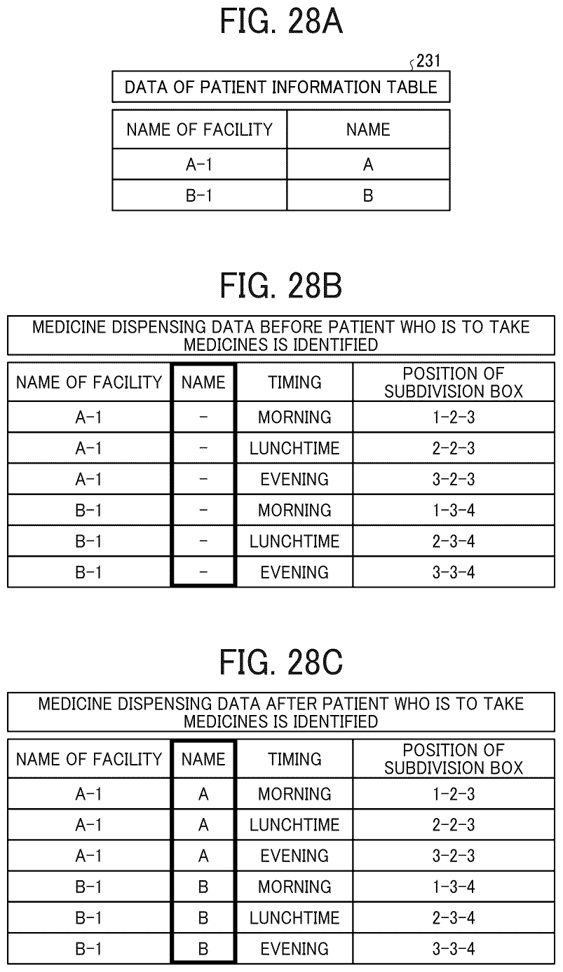

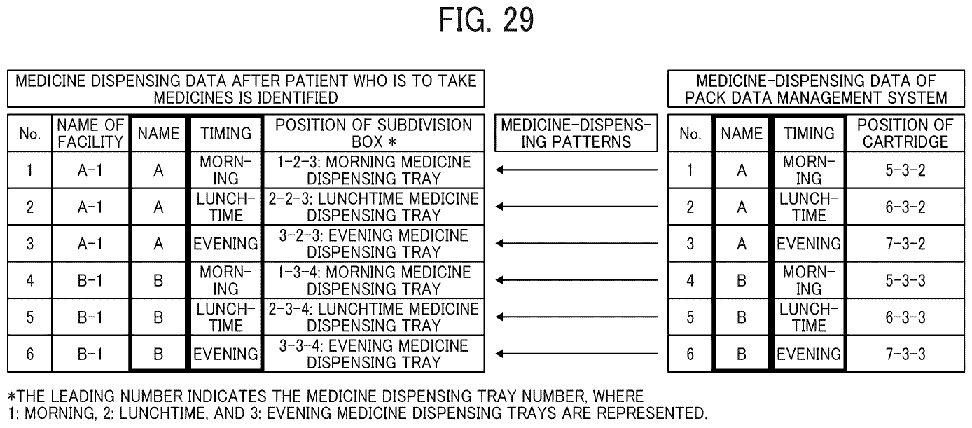

The operation of the patient and medicine-dispensing pattern identification controller 227 is described below with reference to FIG. 27 and FIG. 28. As illustrated in FIG. 27, the patient and medicine-dispensing pattern identification controller 227 is internally provided with a user interface (I/F) 229, a patient information table 230, patient-information table data 231, and a patient identification functional unit/medicine-dispensing pattern identification functional unit 232. As illustrated in FIG. 28A, the patient-information table data 231 is indicated by a table of the names of facilities and the names of patients who take medicines. As illustrated in FIG. 28B and FIG. 28C, the medicine dispensing data of the medicine-dispensing data management system 222 is composed of the name of a facility, the time of medication, and the position of a subdivision box in a medicine dispensing tray.

As illustrated in FIG. 28B, the medicine dispensing data before a patient who is to take medicines is identified does not include the information about the names of the patients who take medicines. In the related art, the information about the names of facilities is not included, but the information about the names of the patients who take medicines is included, which is different from the embodiments of the present disclosure. In the patient identification function, the information about the names of patients who take medicines (where A-1 indicates Mr. or Ms. A and B-1 indicates Mr. or Ms. B) that correspond to the names of facilities is added to the medicine dispensing data in FIG. 28B, based on the patient-information table data in FIG. 28A.

As illustrated in FIG. 29, the medicine-dispensing pattern identification functional unit in FIG. 27 checks the medicine dispensing data after the patients who are to take medicines are identified against the medicine dispensing data of a pack data management system, and identifies the medicine-dispensing patterns. In the identification of the medicine-dispensing patterns, whether the names of patients who take medicines and the times of medication are matched is determined, and the positions of the cartridges 10 are linked to the positions of the subdivision boxes 34 in the medicine dispensing tray 30.

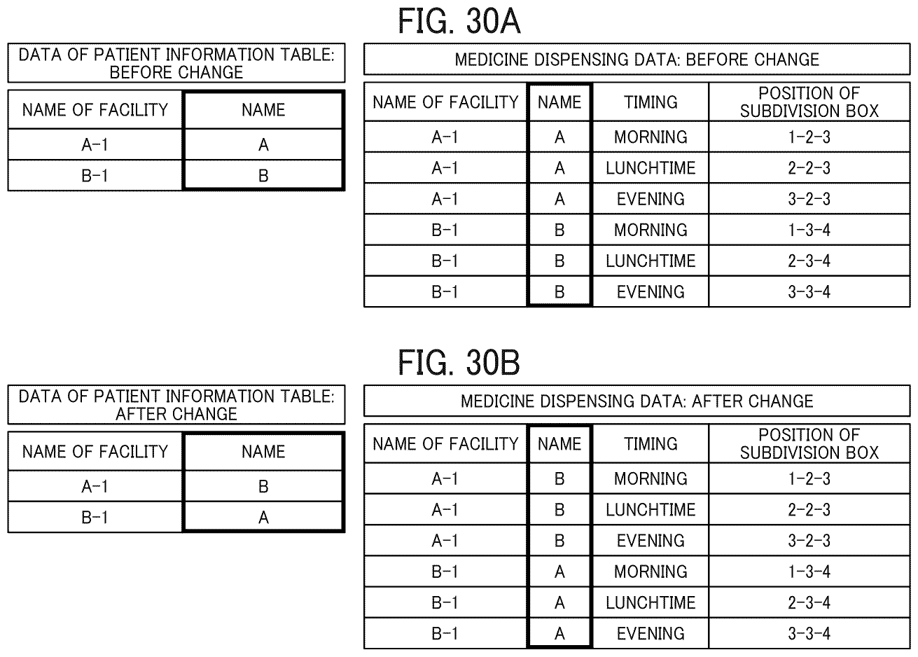

As illustrated in FIG. 30A or FIG. 30B, the patient-information table data 231 can be edited or changed through the user interface 229 of the patient and medicine-dispensing pattern identification controller 227 of FIG. 27. Such editing may be done using an editing function of an application on a personal computer (PC) of an external medicine-dispensing control system.

The above editing may be done by editing the spreadsheet file such as a Microsoft Excel file of the configuration file of FIG. 26, to which input is made. Accordingly, the configuration file of FIG. 26 or the user interface 229 and the patient-information table data 231 of FIG. 27 make up a changer that changes the medicine dispensing data of the specific destination when a medicine package is conveyed to a specific destination of the medicine dispensing tray.

As the destination of the medicine package can be changed easily by such a changer, the workload of QR-code replacement can be reduced. Accordingly, when the information about patients who take medicines in a facility is changed in cases where the cartridges are managed on a patient-by-patient basis and the medicine dispensing trays are managed on a facility-by-facility basis, the workload of QR-code replacement can substantially be eliminated.

FIG. 30A and FIG. 30B illustrate a case where Mr. or Ms. A in facility A-1 and Mr. or Ms. B in facility B-1 switch their facilities, according to a modification. In such a case, Mr. or Ms. A and Mr. or Ms. B are switched in the column of name as changed from FIG. 30A to FIG. 30B using an editing function of an application on a personal computer (PC) of an external medicine-dispensing control system or by editing the spreadsheet file such as a Microsoft Excel file of the configuration file to which input is made. After the patient-information table data 231 is edited, the positions of the subdivision boxes 34 in the medicine dispensing tray 30 for Mr. or Ms. A and Mr. or Ms. B are switched in the medicine dispensing data.

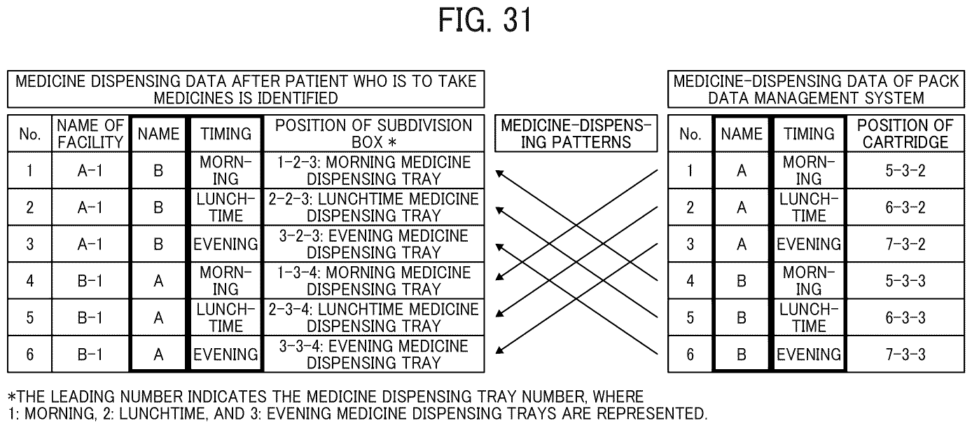

As illustrated in FIG. 31, whether the names of patients who take medicines and the times of medication are matched is determined in the identification of the medicine-dispensing patterns. Accordingly, the positions of the cartridges 10 are linked to the positions of the subdivision boxes 34 in the medicine dispensing tray 30, and in comparison to the medicine-dispensing patterns in FIG. 29 before the data of patient who takes medicines is changed, in the medicine-dispensing patterns in FIG. 31 after the data of patient who takes medicines is changed, the subdivision boxes 34 in the medicine dispensing tray 30 of Mr. or Ms. A are switched with the subdivision boxes 34 in the medicine dispensing tray 30 of Mr. or Ms. B.

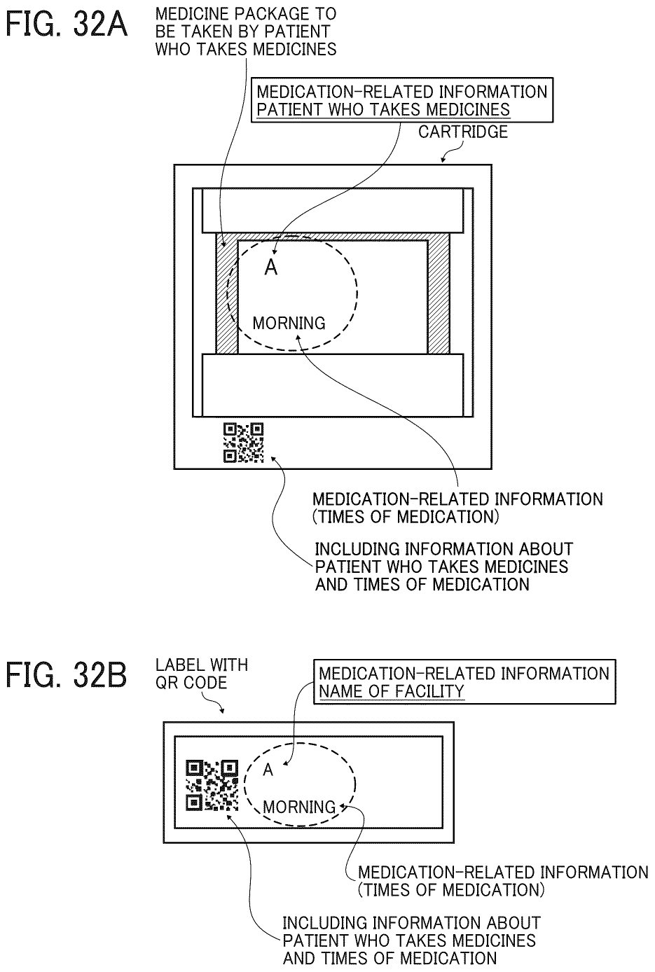

As illustrated in FIG. 32A and FIG. 32B, the medicine dispensing data on the cartridge 10 includes the medication-related information such as the name of a patient who takes medicines and the times of medication. The medicine dispensing data on the subdivision box 34 of the medicine dispensing tray 30 includes the information about the names of facilities and the information about the times of medication. However, in the present embodiment, basically, the medicine dispensing data on the subdivision box 34 of the medicine dispensing tray 30 does not include the information about the patients who take medicines.

In FIG. 32B, cases where the label 7 with a QR CODE is used for the subdivision box 34 of the medicine dispensing tray 30 are illustrated, but it is not necessary to include the information about the patients who take medicines in the QR CODE on the label 7. This is because the information about patients who take medicines can be added by the patient and medicine-dispensing pattern identification controller 227 of the external medicine-dispensing control system 220 illustrated in FIG. 26. Due to such a configuration, sudden changes in the medicine dispensing data such as switching between the patients who take medicines in a facility can flexibly be handled without delay and in an efficient manner.

In other words, changes in the position of the subdivision box on the medicine dispensing tray due to changes in the medicine dispensing data such as switching between the patients who take medicines in a facility can be handled flexibly without delay and in an efficient manner by changing the patient-information table data 231. Accordingly, the need for a physical operation, such as the replacement of the labels 7 with QR CODEs on the subdivision boxes 34 in the medicine dispensing tray 30, can be eliminated. The labels 7 with QR CODEs on the subdivision boxes 34 in the medicine dispensing tray 30 can be used continuously regardless of switching between the patients who take medicines in a facility.

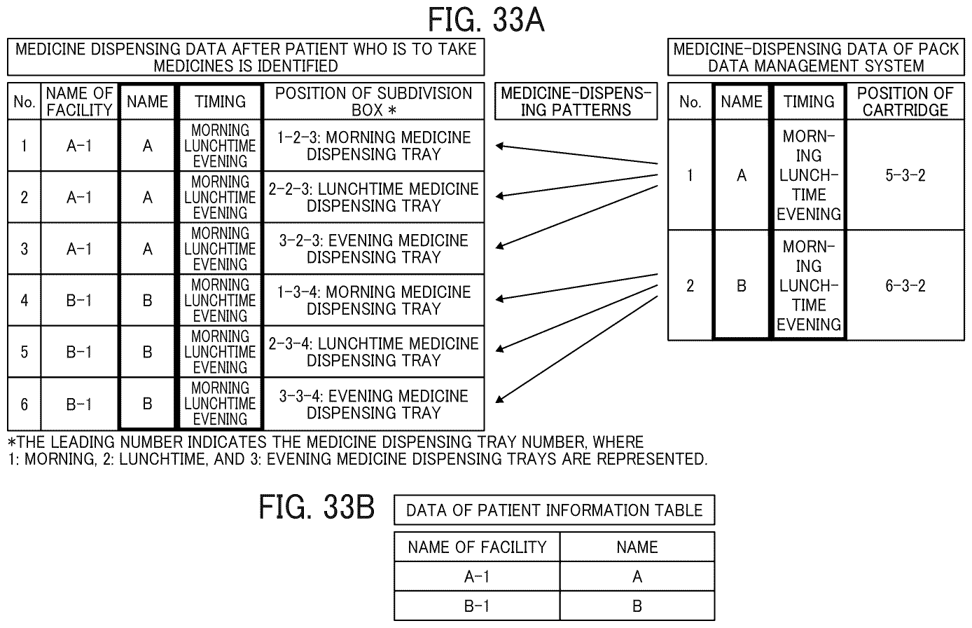

FIG. 33A and FIG. 33B are diagrams illustrating how medicine-dispensing pattern identification is performed.

When the times of medication for patients A and B who take medicines are at three timings including times in the morning, at lunchtime, and in the evening and the medicine packages contain the same medicines in the medication support system according to a comparative example (see FIG. 25), the medicine packages of one type have to be divided into three groups and those three groups of medicine packages have to be placed in three cartridges separately even if the medicine packages to be taken at three different timings contain the same medicines.

By contrast, in FIG. 33A and FIG. 33B, the medicine packages to be dispensed at three timings can be placed in a single cartridges in a collective manner. The information about the times at which medicines are to be dispensed in the medicine dispensing data can be recorded as three timings in the morning, at lunchtime, and in the evening.

By identifying medicine-dispensing patterns upon determining that the name of a patient who takes medicines matches the times at which medicines are to be dispensed, as illustrated in FIG. 33A and FIG. 33B, medicine-dispensing patterns are possible where medicines are dispensed from a single cartridge to three subdivision boxes. In the actual medicine-dispensing operation for the medicine packages, as illustrated in FIG. 3, medicine dispensing trays are separately used for times in the morning, at lunchtime, and in the evening. Accordingly, the chances of error in medicine dispensing operation, such as an error or mistake about times in the morning, at lunchtime, and in the evening, are almost none.

In view of the comparison between the related art described above with reference to FIG. 25 and the present embodiment described with reference to FIG. 33A and FIG. 33B, the number of cartridges can be reduced according to the present embodiment. According to the present embodiment, the man-hours required to perform an operation in which medicine packs are placed in a cartridge can be reduced.

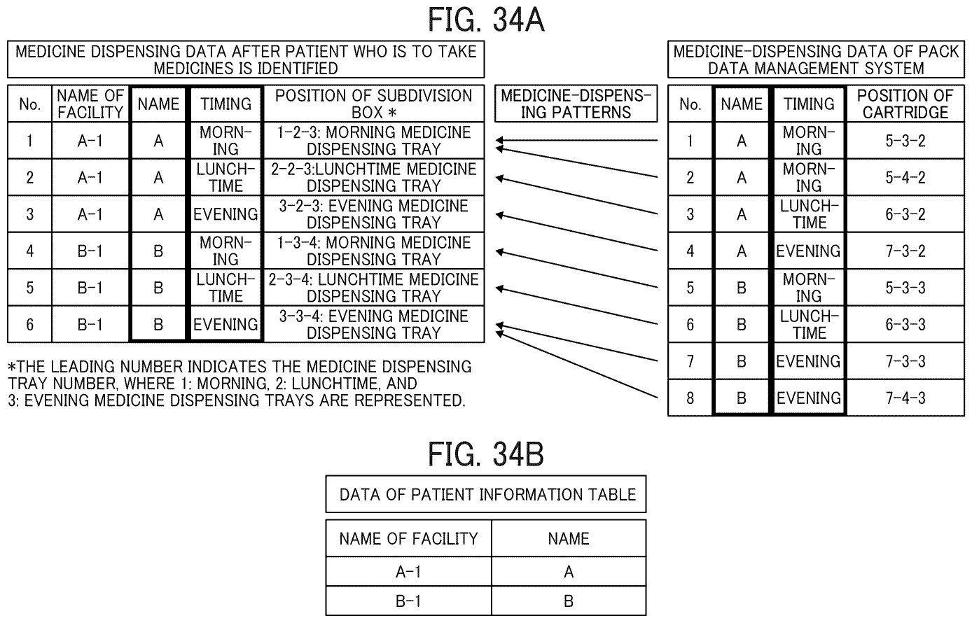

FIG. 34A and FIG. 34B are diagrams illustrating cases in which the medicine-dispensing pattern identification is performed to link the destination of a single medicine package 2 to the multiple medicine dispensing trays 30.

In view of the time of medication in the morning for patient A who takes medicines or the time of medication is in the evening for patient B who takes medicines, the medicine packages 2 of two different types have to be dispensed to a single subdivision box 34 (in one time of medication for the subdivision box 34). In the medication support system according to a comparative example (see FIG. 25), a medicine-dispensing route where one cartridge is assigned to one subdivision box only is identified. Due to such a configuration, two kinds of medicine packages that are divided into two groups and are placed in two cartridges separately cannot be dispensed to a single subdivision box. In such cases, two kinds of medicine packages have to be stapled and placed in a single cartridge.

In the medicine-dispensing pattern identification of FIG. 34A and FIG. 34B, the medicine packages 2 of two types can be dispensed to a single subdivision box 34 after those medicine packages are divided into two groups and are placed in two cartridges 10 (Nos. 1 and 2 and Nos. 7 and 8). In the medicine dispensing data of a pack data management system, the name of a patient who takes medicines and the times at which medicines are to be dispensed can be assigned to a plurality of cartridges with the same name. Due to such a configuration, by identifying medicine-dispensing patterns upon determining that the name of a patient who takes medicines matches the times at which medicines are to be dispensed, medicine-dispensing patterns are possible where medicines are dispensed from a plurality of cartridges to a single subdivision box.

Due to the medicine-dispensing pattern identification of FIG. 34A and FIG. 34B, the stapling operation for medicine packages can be reduced. In the example described with reference to FIG. 34A and FIG. 34B, it is not necessary to staple medicine packages for Mr. or Ms. A to be taken in the morning and medicine packages for Mr. or Ms. B to be taken in the evening. The medicine package that is obtained by stapling a plurality of medicine packages have a higher risk of an error in the medicine dispensing operation than in the case of a medicine package containing only one medicine package. For this reason, in the medication support system described with reference to FIG. 34A and FIG. 34B, the chances of error in the medicine dispensing operation are expected to be lower.

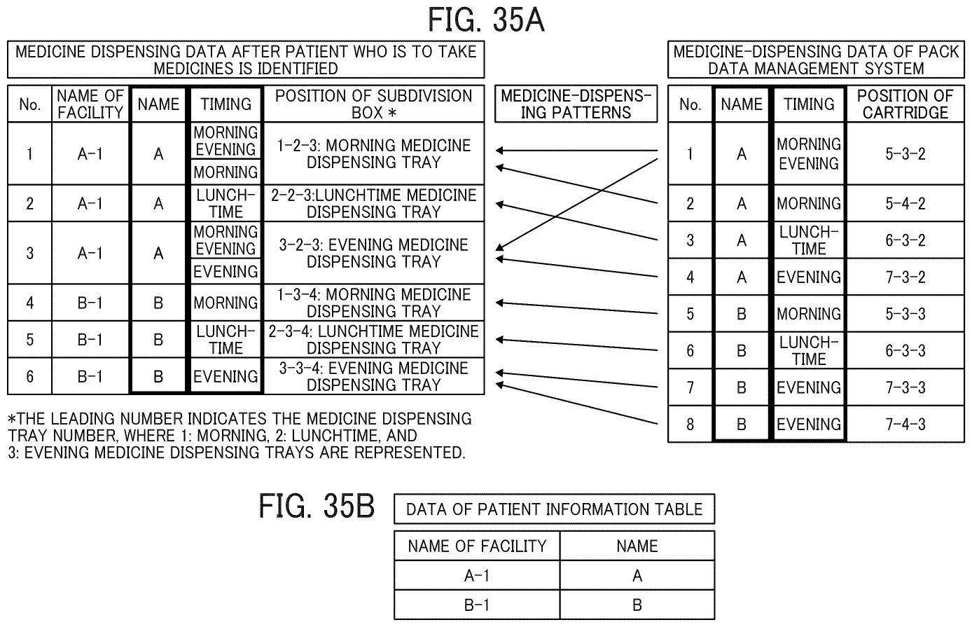

FIG. 35A and FIG. 35B are diagrams illustrating hybrid medicine-dispensing pattern identification in which the medicine-dispensing pattern identification in FIG. 33A and FIG. 33B and is integrated into the medicine-dispensing pattern identification in FIG. 34A and FIG. 34B.

In such medicine-dispensing pattern identification, the coexistence of the medicine-dispensing pattern identification in FIG. 33A and FIG. 33B and the medicine-dispensing pattern identification in FIG. 34A and FIG. 34B is allowed.

In other words, in the medicine dispensing data, the information indicating a plurality of times of medication (i.e., three timings in the morning, at lunchtime, and in the evening as times of medication for Mr. or Ms. A in the example described with reference to FIG. 35A and FIG. 35B) may be mixed with the information indicating that the medicine packages 2 of two different types are to be dispensed to a single subdivision box (in the example described with reference to FIG. 35A and FIG. 35B, the medicine packages placed in the cartridge 10 for Mr. or Ms. A with the timings both in the morning and in the in the evening and the timing in the morning, the cartridge 10 for Mr. or Ms. A with the timings both in the morning and in the evening and the timing in the evening, and the cartridge 10 for Mr. or Ms. B with the timing in the evening are medicine packages containing different types of medicines).

The medicine dispensing data on the subdivision box 34 a plurality of times of medication can be assigned to a single subdivision box 34. Due to such a configuration, by identifying medicine-dispensing patterns upon determining that the name of a patient who takes medicines matches the times at which medicines are to be dispensed, in the example described with reference to FIG. 35A and FIG. 35B, medicine-dispensing patterns where medicines are dispensed from a single cartridge to two subdivision boxes and medicine-dispensing patterns where medicines are dispensed from two cartridges to a single subdivision box can be adopted in a mixed manner.

Due to the medicine-dispensing pattern identification of FIG. 35A and FIG. 35B, the number of cartridges can be reduced, or the man-hours required to perform an operation in which medicine packs are placed in a cartridge can be reduced. Moreover, the stapling operation for medicine packages can be reduced, or the chances of error in the medicine dispensing operation can be reduced.

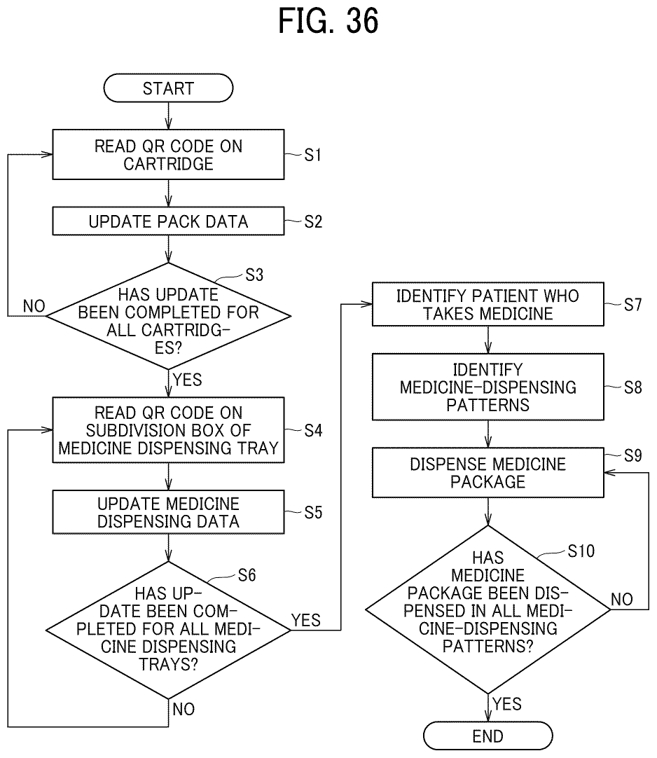

FIG. 36 is a flowchart of a basic medicine dispensing operation.

In step S1, the medicine dispensing data included in the QR CODE of FIG. 32A attached to the cartridge 10 is scanned and read.

The QR CODE is read by the medication-related information reader unit 65 of the medicine dispensing apparatus 200 of FIG. 26. The medicine dispensing controller 224 of the external medicine-dispensing control system 220 in FIG. 26 receives the information about the positions at which the QR-code reading operation is to be performed from the device data manager 225, and notifies the medicine-dispensing apparatus controller 216 of the medicine dispensing apparatus 200 of that information. The medicine-dispensing apparatus controller 216 controls the medication-related information reader unit 65.

The read medicine dispensing data is transferred to the medicine-dispensing data searching system 221 and the pack data management system 223 of the external medicine-dispensing control system 220 through the medicine-dispensing apparatus controller 216 and the communication controller 217, and is stored therein. The medicine dispensing data includes the information about the names of the patients who take medicines and the information about the times of medication.

In step S2, the pack data management system 223 of the external medicine-dispensing control system 220 updates the medicine dispensing data stored in itself to the medicine dispensing data that is read in step S1 and then is transferred thereto.

In step S3, the medicine dispensing controller 224 of the external medicine-dispensing control system 220 determines whether the QR-code reading operation has been performed at all the cartridges 10 based on the information about the installation of the cartridges 10 stored in the device data manager 225.

When the QR-code reading operation is not completed at all the cartridges 10 (NO in step S3), the QR-code reading operation on the cartridge 10 in step S1 and the update of the pack data in step S2 are continued, and are repeated until the QR-code reading operation is completed at all the cartridges 10 (YES in step S3).

In step S4, the medicine dispensing data included in the QR CODE of FIG. 32B attached to the subdivision box 34 of the medicine dispensing tray 30 is scanned and read. The QR CODE is read by the medication-related information reader unit 65 of the medicine dispensing apparatus 200.

The medicine dispensing controller 224 of the external medicine-dispensing control system 220 receives the information about the positions at which the QR-code reading operation is to be performed from the device data manager 225, and notifies the medicine-dispensing apparatus controller 216 of the medicine dispensing apparatus 200 of the received information. The medicine-dispensing apparatus controller 216 controls the medication-related information reader unit 65.

The read medicine dispensing data is transferred to the medicine-dispensing data searching system 221 and the medicine-dispensing data management system 222 of the external medicine-dispensing control system 220 through the medicine-dispensing apparatus controller 216 and the communication controller 217, and is stored therein. The medicine dispensing data includes the information about the names of facilities and the information about the times of medication.

In step S5, the medicine-dispensing data management system 222 of an external medicine-dispensing control system 220 updates the medicine dispensing data stored in itself to the medicine dispensing data that is read in step S4 and then is transferred thereto.

In step S6, the medicine dispensing controller 224 of the external medicine-dispensing control system 220 determines whether the QR-code reading operation has been performed at the subdivision boxes 34 in all the medicine dispensing trays 30 based on the information about the installation of the subdivision boxes 34 in the medicine dispensing trays 30 stored in the device data manager 225. When the QR-code reading operation is not completed on the subdivision boxes 34 in all the medicine dispensing trays 30 (NO in step S6), the QR-code reading operation on each one of the multiple subdivision boxes 34 in the medicine dispensing tray 30 (step S4) and the update of the medicine dispensing data are continued, and are repeated until the QR-code reading operation on all the subdivision boxes 34 in the medicine dispensing tray 30 is completed (YES in step S6).

In step S7, a patient who takes medicines is identified by the patient and medicine-dispensing pattern identification controller 227 of FIG. 27. The patient identification functional unit 232 of the patient and medicine-dispensing pattern identification controller 227 checks the medicine dispensing data sent from the medicine-dispensing data management system 222, i.e., the medicine dispensing data updated in step S5, against the patient-information table data 231, to identify a patient who takes medicines.

In step S8, the medicine dispensing data after a patient who takes medicines is identified in step S7 is checked against the pack data updated in step S2 to identify medicine-dispensing patterns (see the above description with reference to FIG. 29 to FIG. 35B for details).

In step S9, in response to instructions to dispense medicine given from a user, the medicine-dispensing data searching system 221 of the external medicine-dispensing control system 220 instructs the medicine dispensing apparatus 200 to execute the medicine dispensing operation of the medicine package based on the medicine-dispensing pattern data sent from the patient and medicine-dispensing pattern identification controller 227, which is the medicine-dispensing patterns identified in step S7 and step S8. The medicine dispensing controller 224 of the external medicine-dispensing control system 220 provides the medicine dispensing apparatus 200 with the more detailed information about the positions to which medicines are to be dispensed, based on the information about the position of the cartridge 10 and the position of the subdivision box 34 in the medicine dispensing tray 30, which are managed in the device data manager 225. Accordingly, a medicine dispensing operation is executed by the medicine-dispensing apparatus controller 216 of the medicine dispensing apparatus 200.

In step S10, whether all the medicine-dispensing patterns identified in step S8 have been executed in the medicine dispensing operation executed in step S9 is determined. Such determination is made by the medicine-dispensing data searching system 221 of the external medicine-dispensing control system 220. Whether to terminate the processes is determined based on the instructions to dispense medicines given by a user and the medicine-dispensing pattern data sent from the patient and medicine-dispensing pattern identification controller 227.

When the medicine-dispensing patterns are not all completed (NO in step S10), the execution of the medicine dispensing operation of the medicine package in step S9 is continued and repeated until the medicine-dispensing patterns are all completed (YES in step S10) and the medicine dispensing operation is to be ended. When the medicine-dispensing patterns are all completed (YES in step S10), the medicine dispensing controller 224 of the external medicine-dispensing control system 220 instructs the medicine-dispensing apparatus controller 216 of the medicine dispensing apparatus 200 to end the medicine dispensing operation, and the medicine dispensing operation of the entirety of the medicine dispensing apparatus 200 is terminated.

Aspects of the present disclosure are described below.

### First Aspect

A medication support system includes a medicine dispensing apparatus and an external medicine-dispensing control system to manage the medicine dispensing apparatus. The medicine dispensing apparatus includes a container to store a plurality of medicine packs to each of which medication-related information including a name of a patient who takes a medicine and a time of medication is added, a medicine dispensing tray to which medicine dispensing data including information about at least one of the plurality of medicine packs to be dispensed is added, a conveying device to pick up one of the plurality of medicine packs from the container and convey the picked-up one of the plurality of medicine packs to a specific destination in the medicine dispensing tray, and a pack data reader to read the medication-related information added to the plurality of medicine packs or the container and the medicine dispensing data added to the medicine dispensing tray and including information about the at least one of the plurality of medicine packs to be dispensed. The external medicine-dispensing control system includes an identification controller to identify the specific destination of the picked-up one of the plurality of medicine packs in the medicine dispensing tray based on the medication-related information of the medicine pack and the medicine dispensing data added to the medicine dispensing tray, and a changer to change the medicine dispensing data of the specific destination.

Accordingly, changes on the medicine dispensing data such as switching between patients who take medicines in a facility can be handled flexibly without delay and in an efficient manner.

### Second Aspect

In the medication support system according to the first aspect, the medicine dispensing data related to the specific destination of the plurality of medicine packs includes information indicating that a destination of one of the plurality of medicine packs is linked to a plurality of medicine dispensing trays.

In a comparative example, the destination of a single medicine pack is linked to the subdivision boxes of a single medicine dispensing tray. Accordingly, when the medicine packs containing the same medicines are to be dispensed to the subdivision boxes of a plurality of medicine dispensing trays, the number of cartridges to store medicine packs has to be equal to or greater than the number of subdivision boxes in each medicine dispensing tray. Because of the structure that requires the cartridge to store a larger number of medicine packs, the footprint tends to be large. Furthermore, an operation in which the medicine pack is placed in the cartridge has to be repeated for each one of the subdivision boxes of the medicine dispensing tray. In the medication support system according to the second aspect, the packs containing the same medicines can be conveyed to the subdivision boxes of the multiple medicine dispensing trays. Accordingly, the number of cartridges can be reduced, and the footprint requirements for the medication support system can be reduced. Moreover, the man-hours required to perform an operation in which the medicine packs are placed in the cartridge can be reduced.

### Third Aspect

In the medication support system according to the first aspect, the medicine dispensing data related to the specific destination of the plurality of medicine packs includes information indicating that a destination of the plurality of medicine packs is linked to a single medicine dispensing tray.

In a comparative example, the destination of a single medicine pack is linked to a single medicine dispensing tray. In such a configuration, when a plurality of medicine packs of different types are dispensed to some of the subdivision boxes of a single medicine dispensing tray, such a plurality of medicine packages are stapled. With the medication support system according to the third aspect, the above stapling operation can be reduced or eliminated. The medicine package obtained by stapling a plurality of medicine packages has a higher risk of an error in medicine dispensing operation than in the case of a medicine package containing only one medicine package, but with the medication support system according to the third aspect, the chances of error in medicine dispensing operation are expected to be reduced.

### Fourth Aspect

In the medication support system according to the first aspect, the medicine dispensing data related to the specific destination of the plurality of medicine packs includes both information indicating that a destination of one of the plurality of medicine packs is linked to a plurality of medicine dispensing trays and information indicating that a destination of the plurality of medicine packs is linked to a single medicine dispensing tray.

Accordingly, advantageous effects similar to those of the second aspect and the third aspect can be achieved.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A medication support system comprising:
a medicine dispensing apparatus including
a container to store a plurality of medicine packs to each of which medication-related information including a name of a patient who takes a medicine and a time of medication is added,
a medicine dispensing tray to which medicine dispensing data including information about at least one of the plurality of medicine packs to be dispensed is added,
a conveying device to pick up one of the plurality of medicine packs from the container and convey the picked-up one of the plurality of medicine packs to a specific destination in the medicine dispensing tray, and
a pack data reader to read the medication-related information added to the plurality of medicine packs or the container and the medicine dispensing data added to the medicine dispensing tray and including information about the at least one of the plurality of medicine packs to be dispensed; and
an external medicine-dispensing control system to manage the medicine dispensing apparatus, the external medicine-dispensing control system including processing circuitry configured to
identify the specific destination of the picked-up one of the plurality of medicine packs in the medicine dispensing tray based on the medication-related information of the medicine pack and the medicine dispensing data added to the medicine dispensing tray, and
change the medicine dispensing data of the specific destination.

2. The medication support system according to claim 1, further comprising
a plurality of medicine dispensing trays including the medicine dispensing tray,
wherein the medicine dispensing data related to the specific destination of the plurality of medicine packs includes information indicating that a destination of one of the plurality of medicine packs is linked to the plurality of medicine dispensing trays.

3. The medication support system according to claim 1, further comprising
a plurality of medicine dispensing trays including the medicine dispensing tray,
wherein the medicine dispensing data related to the specific destination of the plurality of medicine packs includes information indicating that a destination of the plurality of medicine packs is linked to one of the plurality of medicine dispensing trays.

4. The medication support system according to claim 1, further comprising
a plurality of medicine dispensing trays including the medicine dispensing tray,
wherein the medicine dispensing data related to the specific destination of the plurality of medicine packs includes both information indicating that a destination of one of the plurality of medicine packs is linked to the plurality of medicine dispensing trays and information indicating that a destination of the plurality of medicine packs is linked to one of the plurality of medicine dispensing trays.
